(19) United States
(12) Patent Application Publication
(10) Pub. No.: US 2025/0076621 A1
(43) Pub. Date: Mar. 6, 2025

(54) LOW PARALLAX LENS DESIGN WITH IMPROVED PERFORMANCE

(71) Applicant: Circle Optics, Inc., Rochester, NY (US)

(72) Inventors: John Bowron, Burlington (CA); Andrew F. Kurtz, Macedon, NY (US); Adam Briggs, Jefferson Hills, PA (US); Peter Dean-Erlander, Boise, ID (US)

(73) Assignee: Circle Optics, Inc., Rochester, NY (US)

(21) Appl. No.: 18/488,763

(22) PCT Filed: Dec. 22, 2021
(86) PCT No.: PCT/US2021/065002

§ 371 Date: Oct. 17, 2023

Related U.S. Application Data
(63) Continuation of application No. PCT/US2021/007284, filed on Feb. 9, 2021.
(60) Provisional application No. 63/185,042, filed on May 6, 2021.

(51) Int. Cl. G02B 13/06; G02B 13/18; G02B 27/00; G03B 37/04

(52) U.S. Cl. CPC G02B 13/06; G02B 13/18; G02B 27/0056; G03B 37/04

(57) ABSTRACT

A lens form for a low parallax imaging device includes a plurality of imaging lens elements arranged to capture and image polygonal fields of view. The lens form includes a compression lens element group and a wide-angle lens element group.

### CROSS REFERENCE TO RELATED APPLICATIONS

This application claims benefit of priority of International Patent Application PCT/US21/65002, filed Dec. 22, 2021, entitled, “LOW PARALLAX LENS DESIGN WITH IMPROVED PERFORMANCE”, U.S. Provisional Patent Application Ser. No. 63/185,042, filed May 6, 2021, entitled “Low Parallax Lens Design with Improved Performance”, and International Patent Application No. PCT/US21/17284, filed Feb. 9, 2021, entitled “Panoramic Camera System for Enhanced Sensing”, each of which is incorporated herein by reference.

### TECHNICAL FIELD

The present disclosure relates to panoramic low-parallax multi-camera capture devices having a plurality of adjacent and abutting polygonal cameras. The disclosure also relates to lens designs for cameras that capture incident light from a polygonal shaped field of view to form a polygonal shaped image with improved parallax and front color performance.

### BACKGROUND

Panoramic cameras have substantial value because of their ability to simultaneously capture wide field of view images. The earliest such example is the fisheye lens, which is an ultra-wide-angle lens that produces strong visual distortion while capturing a wide panoramic or hemispherical image. While the field of view (FOV) of a fisheye lens is usually between 100 and 180 degrees, the approach has been extended to yet larger angles, including into the 220-270° range, as provided by Y. Shimizu in U.S. Pat. No. 3,524,697.

As another alternative, panoramic multi-camera devices, with a plurality of cameras arranged around a sphere or a circumference of a sphere, are becoming increasingly common. However, in most of these systems, including those described in U.S. Pat. Nos. 9,451,162 and 9,911,454, both to A. Van Hoff et al., of Jaunt Inc., the plurality of cameras are sparsely populating the outer surface of the device. In order to capture complete 360-degree panoramic images, including for the gaps or seams between the adjacent individual cameras, the cameras then have widened FOVs that overlap one to another. In some cases, as much as 50% of a camera's FOV or resolution may be used for camera to camera overlap, which also creates substantial parallax differences between the captured images. Parallax is the visual perception that the position or direction of an object appears to be different when viewed from different positions. Then in the subsequent image processing, the excess image overlap and parallax differences both complicate and significantly slow the efforts to properly combine, tile or stitch, and synthesize acceptable images from the images captured by adjacent cameras.

There are also panoramic multi-camera devices in which a plurality of cameras is arranged around a sphere or a circumference of a sphere, such that adjacent cameras are abutting along a part or the whole of adjacent edges. As an example, U.S. Pat. No. 7,515,177 by K. Yoshikawa depicts an imaging device with a multitude of adjacent image pickup units (cameras). Images are collected from cameras having overlapping fields of view, so as to compensate for mechanical errors.

There remain opportunities to improve the lens designs and function of imaging lens systems that can be used in low parallax panoramic multi-camera devices. The potential optical improvements could also have direct and indirect benefit or synergy for the opto-mechanical designs of the individual camera lens systems and the overall device, particularly as related to issues at or near the seams between adjacent cameras.

### BRIEF DESCRIPTION OF THE DRAWINGS

FIG. 1 depicts a 3D view of a portion of a multi-camera capture device, and specifically two adjacent cameras thereof.

FIGS. 2A and 2B depict portions of camera lens assemblies in cross-section, including lens elements and ray paths.

FIG. 3 depicts a cross-sectional view of a portion of a standard multi-camera capture device showing FOV overlap, Fields of view, overlap, seams, and blind regions.

FIG. 4A and FIG. 4B depict the optical geometry for fields of view for adjacent hexagonal and pentagonal lenses, as can occur with a device having the geometry of a truncated icosahedron. FIG. 4B depicts an expanded area of FIG. 4A with greater detail.

FIG. 4C depicts an example of a low parallax (LP) volume located near both a paraxial NP point or entrance pupil and a device center.

FIG. 4D depicts parallax differences for a camera channel, relative to a center of perspective.

FIG. 4E depicts front color at an edge of an outer compressor lens element.

FIG. 5 depicts fields of view for adjacent cameras, including both Core and Extended fields of view (FOV), both of which can be useful for the design of an optimized panoramic multi-camera capture device.

FIG. 6 depicts a cross-sectional view of an example objective lens.

FIG. 7 is a flow chart illustrating a lens design method according to the present invention.

FIG. 8A depicts a cross-sectional view of a two-element compressor lens group as designed in isolation according to the lens design method.

FIG. 8B depicts a cross-sectional view of the chief rays being directed toward a temporary aperture stop created by the compressor lens elements as designed in isolation according to the lens design method.

FIG. 9A depicts an improved imaging lens system designed using the lens design method of FIG. 7, having both reduced parallax and front color.

FIG. 9B depicts a cross sectional view of a low parallax volume for the lens of FIG. 9A.

FIG. 9C depicts parallax correction curves plotted on a graph showing residual parallax error as chief ray field angle error in degrees versus the field of view in degrees for the lens of FIG. 9A.

FIG. 9D depicts the residual front color for the lens of FIG. 9A.

FIG. 9E depicts the lens prescription for the lens of FIG. 9A.

FIG. 9F depicts the thermal sensitivity for the lens of FIG. 9A.

FIG. 10A depicts a cross-sectional view of an example improved imaging lens system designed according to the new lens design method of FIG. 7.

FIG. 10B depicts a cross-sectional view of another example improved imaging lens system.

FIG. 11A depicts a cross-sectional view of another example improved imaging lens system.

FIG. 11B depicts a cross-sectional view of the pre-aperture stop portion of an additional example improved imaging lens system

FIG. 11C depicts a cross-sectional view of another example improved imaging lens system.

FIG. 11D depicts a cross-sectional view of the low-parallax volume of the example improved imaging lens system of FIG. 11C.

### DETAILED DESCRIPTION

As is generally understood in the field of optics, a lens or lens assembly typically comprises a system or device having multiple lens elements which are mounted into a lens barrel or housing, and which work together to produce an optical image. An imaging lens captures a portion of the light coming from an object or plurality of objects that reside in object space at some distance(s) from the lens system. The imaging lens can then form an image of these objects at an output “plane”; the image having a finite size that depends on the magnification, as determined by the focal length of the imaging lens and the conjugate distances to the object(s) and image plane, relative to that focal length. The amount of image light that transits the lens, from object to image, depends in large part on the size of the aperture stop of the imaging lens, which is typically quantified by one or more values for a numerical aperture (NA) or an f-number (F# or F/#).

The image quality provided by the imaging lens depends on numerous properties of the lens design, including the selection of optical materials used in the design, the size, shapes (or curvatures) and thicknesses of the lens elements, the relative spacing of the lens elements one to another, the spectral bandwidth, polarization, light load (power or flux) of the transiting light, optical diffraction or scattering, and/or lens manufacturing tolerances or errors. The image quality is typically described or quantified in terms of lens aberrations (e.g., spherical, coma, astigmatism, or distortion), or the relative size of the resolvable spots provided by the lens. The resolution provided by an imaging lens is typically quantified by the modulation transfer function (MTF).

In a typical electronic or digital camera, an image sensor which is typically a CCD or CMOS device, is nominally located at the image plane.

In typical use, a camera images an environment and objects therein. If the camera is moved to a different nearby location and used to capture another image of part of that same scene, both the apparent perspectives and relative positioning of the objects will change. In the latter case, one object may now partially occlude another, while a previously hidden object becomes at least partially visible. These differences in the apparent position or direction of an object are known as parallax. In particular, parallax is a displacement or difference in the apparent position of an object viewed along two different lines of sight and is measured by the angle or semi-angle of inclination between those two lines. In a panoramic image capture application, parallax differences can be regarded as an error that can complicate both image stitching and appearance, causing visual disparities, image artifacts, exposure differences, and other errors. Although the resulting images can often be successfully stitched together with image processing algorithms, the input image errors complicate and lengthen image processing time, while sometimes leaving visually obvious residual errors.

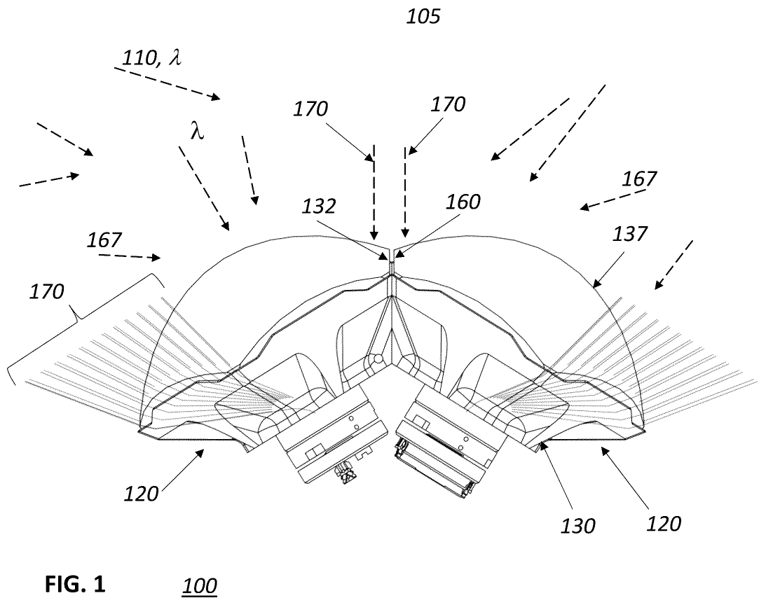

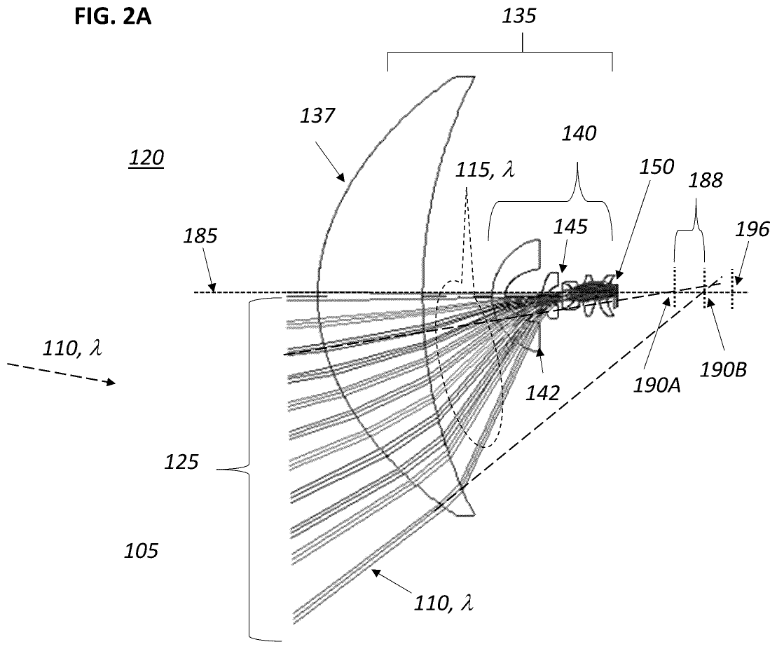

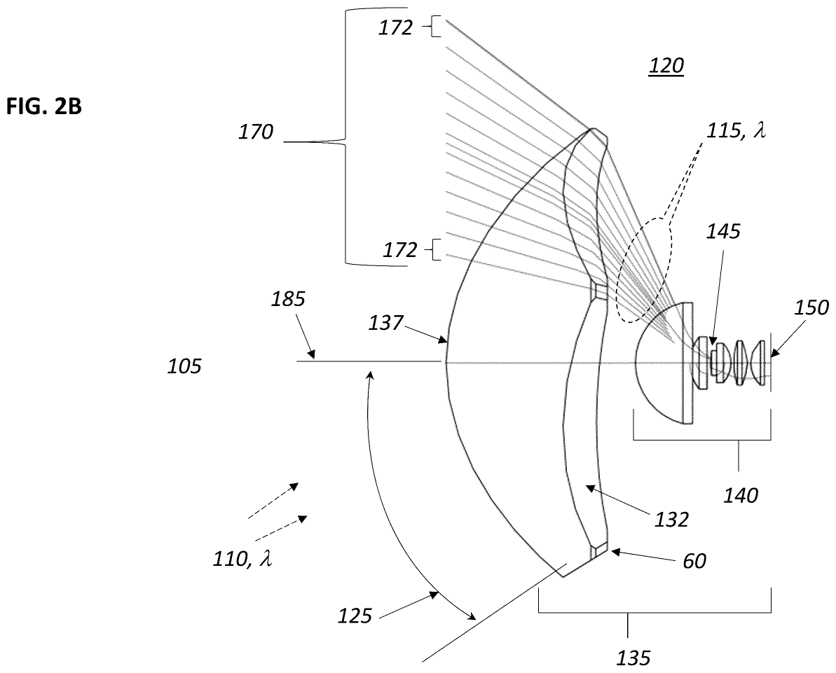

To provide context, FIG. 1 depicts a portion of an improved integrated panoramic multi-camera capture device 100 having two adjacent cameras 120 in housings 130 which are designed for reduced parallax image capture. These cameras are alternately referred to as camera channels, or objective lens systems. The cameras 120 each have a plurality of lens elements (see FIG. 2) that are mounted within a lens barrel or housing 130. The adjacent outer lens elements 137 have adjacent beveled edges 132 and are proximately located, one camera channel to another, but which may not be in contact, and thus are separated by a gap or seam 160 of finite width. Some portion of the available light (λ), or light rays 110, from a scene or object space 105 will enter a camera 120 to become image light that was captured within a constrained FOV and directed to an image plane, while other light rays will miss the cameras entirely.

In greater detail, FIG. 2A depicts a cross-section of part of a camera 120 having a set of lens elements 135 mounted in a housing (130, not shown) within a portion of an integrated panoramic multi-camera capture device 100. A fan of light rays 110 from object space 105, spanning the range from on axis to full field off axis chief rays, are incident onto the outer lens element 137, and are refracted and transmitted inwards. Each chief ray is shown with an adjacent ray to either side, representing a local light beam. This image light 115 that is refracted and transmitted through further inner lens elements 140, through an aperture stop 145, converges to a focused image at or near an image plane 150, where an image sensor (not shown) is typically located. The lens system 120 of FIG. 2A can also be defined as having a lens form that consists of outer lens element 137 or compressor lens element, and inner lens elements 140, the latter of which can also be defined as consisting of a pre-stop wide angle lens group, and a post-stop eyepiece-like lens group. This compressor lens element (137) directs the image light 115 sharply inwards, compressing the light, to both help enable the overall lens assembly to provide a short focal length, while also enabling the needed room for the camera lens housing or barrel to provide the mechanical features necessary to both hold or mount the lens elements and to interface properly with the barrel or housing of an adjacent camera. The image light that transited a camera lens assembly from the outer lens element 137 to the image plane 150 will provide an image having an image quality, that can be quantified by an image resolution, image contrast, a depth of focus, and other attributes, whose quality was defined by the optical aberrations (e.g., astigmatism, distortion, or spherical) and chromatic or spectral aberrations, encountered by the transiting light at each of the lens elements (137, 140) within a camera 120. FIG. 2B depicts a fan of chief rays 170, or perimeter rays, incident along or near a beveled edge 132 of the outer lens element 137 of the camera optics (120) depicted in FIG. 2A. FIG. 2B also depicts a portion of a captured, polygonal shaped or asymmetrical, FOV 125, that extends from the optical axis 185 to a line coincident with an edge ray.

The images produced by a plurality of cameras in an integrated panoramic multi-camera capture device 100 can be impacted by the directional pointing or collection of image light through the lens elements to the image sensor of any given camera 120, such that the camera captures an angularly skewed or asymmetrical FOV (FOV↔) or mis-sized FOV (FOV±). The lens pointing variations can occur during fabrication of the camera (e.g., lens elements, sensor, and housing) or during the combined assembly of the multiple cameras into an integrated panoramic multi-camera capture device 100, such that the alignment of the individual cameras is skewed by misalignments or mounting stresses. When these camera pointing errors are combined with the presence of the seams 160 between cameras 120, images for portions of an available landscape or panoramic FOV that may be captured, may instead be missed, or captured improperly. The variabilities of the camera pointing, and seams can be exacerbated by mechanical shifts and distortions that are caused by internal or external environmental factors, such as heat or light (e.g., image content), and particularly asymmetrical loads thereof.

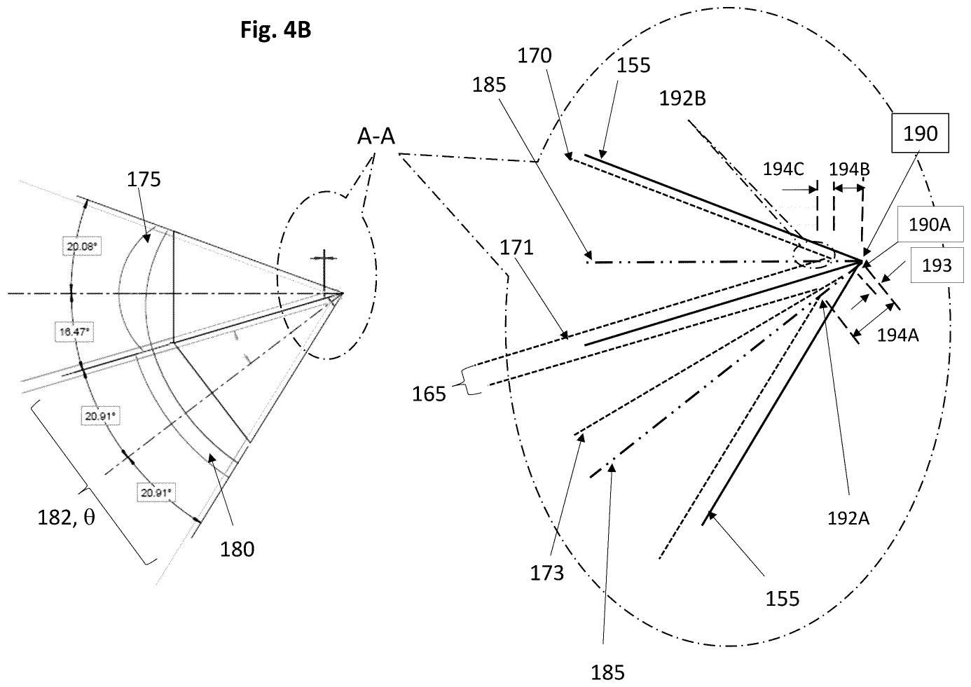

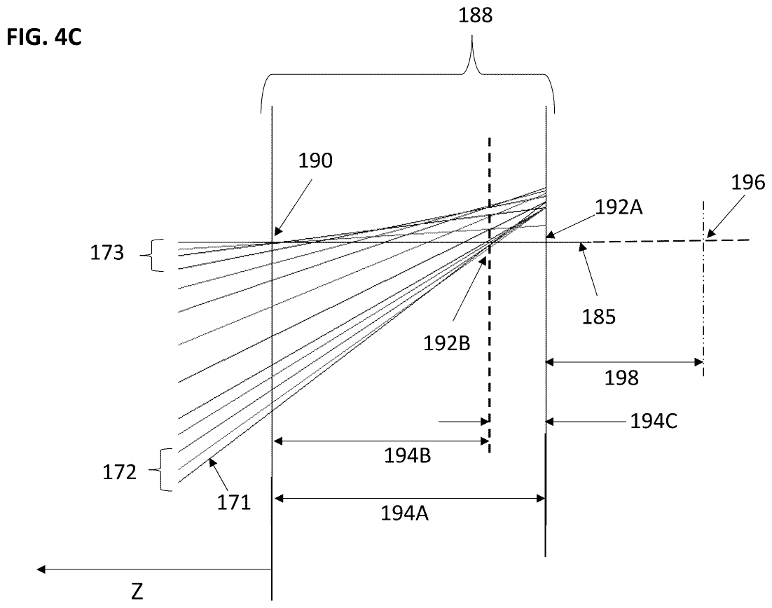

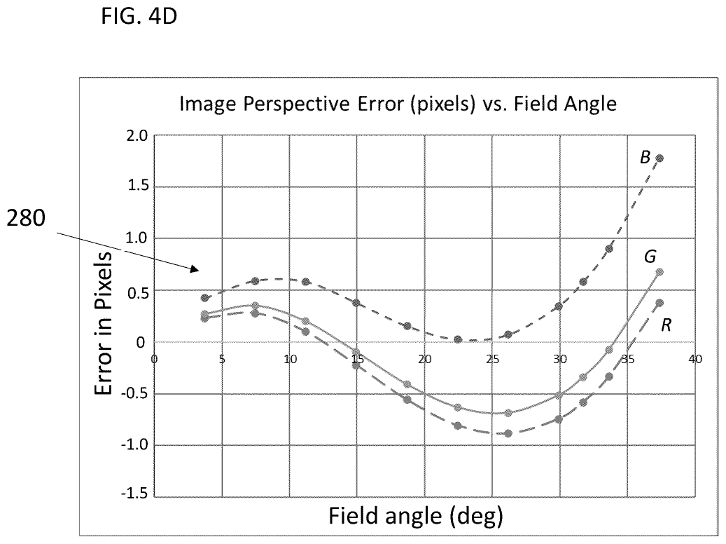

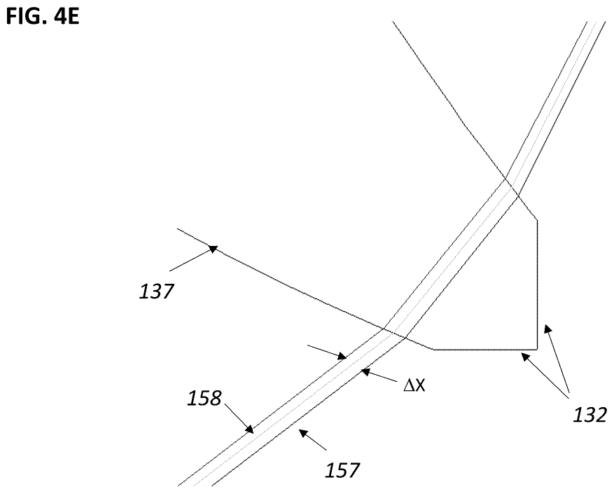

To help illustrate some issues relating to camera geometry, FIG. 4A illustrates a cross-sections of a pentagonal lens 175 capturing a pentagonal FOV 177 and a hexagonal lens 180 capturing a hexagonal FOV 182, representing a pair of adjacent cameras whose outer lens elements have pentagonal and hexagonal shapes, as can occur with a truncated icosahedron, or soccer ball type panoramic multi-camera capture devices (e.g., 100, 300). The theoretical hexagonal FOV 182 spans a half FOV of 20.9°, or a full FOV of 41.8° (θ1) along the sides, although the FOV near the vertices is larger. The pentagonal FOV 177 supports 36.55° FOV (θ2) within a circular region, and larger FOVs near the corners or vertices. Notably, in this cross-section, the pentagonal FOV 177 is asymmetrical, supporting a 20-degree FOV on one side of an optical axis 185, and only a 16.5-degree FOV on the other side of the optical axis.

When designing a lens system for an improved low-parallax multi-camera panoramic capture device (300), there are several factors that affect performance (including, particularly parallax) and several parameters that can be individually or collectively optimized, so as to control it. One approach for parallax control during lens optimization targets the “NP” point, or more significantly, variants thereof. As background, in the field of optics, there is a concept of the entrance pupil, which is a projected image of the aperture stop as seen from object space, or a virtual aperture which the imaged light rays from object space appear to propagate towards before any refraction by the first lens element. By standard practice, the location of the entrance pupil can be found by identifying a paraxial chief ray from object space 105, that transits through the center of the aperture stop, and projecting or extending its object space direction forward to the location where it hits the optical axis 185. In optics, incident Gauss or paraxial rays are generally understood to reside within an angular range less than or equal to 10° from the optical axis, and correspond to rays that are directed towards the center of the aperture stop, and which also define the entrance pupil position. Depending on the lens properties, the entrance pupil may be bigger or smaller than the aperture stop, and located in front of, or behind, the aperture stop.

By comparison, in the field of low-parallax cameras, there is a concept of a no-parallax (NP) point, or viewpoint center. Conceptually, an NP point associated with the paraxial entrance pupil can be helpful in developing initial specifications for designing the lens, and for describing the lens. Whereas an NP point associated with non-paraxial edge of field chief rays can be useful in targeting and understanding parallax performance and in defining the conical volume or frustum that the lens assembly can reside in. The projection of chief rays, and particularly non-paraxial chief rays can miss the paraxial chief ray defined entrance pupil because of both lens aberrations and practical geometry related factors associated with these lens systems. Relative to the former, in a well-designed lens, image quality at an image plane is typically prioritized by limiting the impact of aberrations on resolution, telecentricity, and other attributes. Within a lens system, aberrations at interim surfaces, including the aperture stop, can vary widely, as the emphasis is on the net sums at the image plane. Aberrations at the aperture stop are often somewhat controlled to avoid vignetting, but a non-paraxial chief ray need not transit the center of the aperture stop or the projected paraxially located entrance pupil.

To expand on these concepts, and to enable the design of improved low parallax lens systems, it is noted that the camera lens system 120 in FIG. 2A depicts both a first NP point 190A, corresponding to the entrance pupil as defined by a vectoral projection of paraxial chief rays from object space 105, and an offset second NP point 190B, corresponding to a vectoral projection of a non-paraxial chief rays from object space. Both of these virtual ray projections cross the optical axis 185 in locations behind both the lens system and the image plane 150. As will be subsequently discussed, the ray behavior in the region between and proximate to the projected points 190A and 190B can be complicated and neither projected location or point has a definitive value or size. A projection of a chief ray will cross the optical axis at a point, but a projection of a group of chief rays will converge towards the optical axis and cross at different locations, that can be tightly clustered (e.g., within a few or tens of microns), where the extent or size of that “point” can depends on the collection of proximate chief rays used in the analysis. Whereas, when designing low parallax imaging lenses that image large FOVs, the axial distance or difference between the NP points 190A and 190B that are provided by the projected paraxial and non-paraxial chief rays can be significantly larger (e.g., millimeters). Thus, as will also be discussed, the axial difference represents a valuable measure of the parallax optimization (e.g., a low parallax volume 188) of a lens system designed for the current panoramic capture devices and applications. As will also be seen, the design of an improved device (300) can be optimized to position the geometric center of the device, or device center 196, outside, but proximate to this low parallax volume 188, or alternately within it, and preferably proximate to a non-paraxial chief ray NP point.

As one aspect, FIG. 4A depicts the virtual projections of the theoretical edge of the fields of view (FOV edges 155), past the outer lens elements (lenses 175 and 180) of two adjacent cameras, to provide lines directed to a common point (190). These lines represent theoretical limits of the complex “conical” opto-mechanical lens assemblies, which typically are pentagonal conical or hexagonally conical limiting volumes. Again, ideally, in a no-parallax multi-camera system, the entrance pupils or NP points of two adjacent cameras are co-located. But to avoid mechanical conflicts, the mechanics of a given lens assembly, including the sensor package, should generally not protrude outside a frustum of a camera system and into the conical space of an adjacent lens assembly. However, real lens assemblies in a multi-camera panoramic capture device are also separated by seams 160. Thus, the real chief rays 170 that are accepted at the lens edges, which are inside of both the mechanical seams and a physical width or clear aperture of a mounted outer lens element (lenses 175 and 180), when projected generally towards a paraxial NP point 190, can land instead at offset NP points 192, and be separated by an NP point offset distance 194.

This can be better understood by considering the expanded area A-A in proximity to a nominal or ideal point NP 190, as shown in detail in FIG. 4B. It should be understood that FIGS. 4A-4C progress forwards in relative finer scales, and for example, not all details presented in FIG. 4C are visible in FIG. 4A or FIG. 4B. In FIG. 4B, within a hexagonal FOV 182, light rays that propagate within the Gauss or paraxial region (e.g., paraxial ray 173), and that pass through the nominal center of the aperture stop, can be projected to a nominal NP point 190 (corresponding to the entrance pupil), or to an offset NP point 190A at a small NP point difference or offset 193 from a nominal NP point 190. Whereas, the real hexagonal lens edge chief rays 170 associated with a maximum inscribed circle within a hexagon, can project to land at a common offset NP point 192A that can be at a larger offset distance (194A). The two adjacent cameras in FIGS. 4A,B also may or may not share coincident NP points (e.g., 190). Distance offsets can occur due to various reasons, including geometrical concerns between cameras (adjacent hexagonal and pentagonal cameras), geometrical asymmetries within a camera (e.g., for a pentagonal camera), or from limitations from the practical widths of seams 160, or because of the directionality difference amongst aberrated rays.

As just noted, there are also potential geometric differences in the virtual projections of incident chief rays towards a simplistic nominal “NP point” (190). First, incident imaging light paths from near the corners or vertices or mid-edges (mid-chords) of the hexagonal or pentagonal lenses may or may not project to common NP points within the described range between the nominal paraxial NP point 190 and an offset NP point 192B. Also, as shown in FIG. 4B, just from the geometric asymmetry of the pentagonal lenses, the associated pair of edge chief rays 170 and 171 for the real accepted FOV, can project to different nominal NP points 192B that can be separated from both a paraxial NP point (190) by an offset distance 194B and from each other by an offset distance 194C.

As another issue, during lens design, the best performance typically occurs on axis, or near on axis (e.g., less than or equal to 0.3 field (normalized)), near the optical axis 185. In many lenses, good imaging performance, by design, often occurs at or near the field edges, where optimization weighting is often used to force compliance. The worst imaging performance can then occur at intermediate fields (e.g., 0.7-0.8 of a normalized image field height). Considering again FIG. 4A,B, intermediate off axis rays, from intermediate fields (θ) outside the paraxial region, but not as extreme as the edge chief rays (10°<θ<20.9°), can project towards intermediate NP points between a nominal NP point 190 and an offset NP point 192B. But other, more extreme off axis rays, particularly from the 0.7-0.8 intermediate fields, that are more affected by aberrations, can project to NP points at locations that are more or less offset from the nominal NP point 190 than are the edge of field offset NP points 192B. Accounting for the variations in lens design, the non-paraxial offset “NP” points can fall either before (closer to the lens) the paraxial NP point (the entrance pupil) as suggested in FIG. 4B, or after it (as shown in FIG. 2A).

This is shown in greater detail in FIG. 4C, which essentially illustrates a further zoomed-in region A-A of FIG. 4B, but which illustrates an impact from vectoral projected ray paths associated with aberrated image rays, that converge at and near the paraxial entrance pupil (190), for an imaging lens system that was designed and optimized using the methods of the present approach. In FIG. 4C, the projected ray paths of green aberrated image rays at multiple fields from a camera lens system converge within a low parallax volume 188 near one or more “NP” points. Similar illustrations of ray fans can also be generated for Red or Blue light. The virtual projection of paraxial rays 173 can converge at or near a nominal paraxial NP point 190, or entrance pupil, located on a nominal optical axis 185 at a distance Z behind the image plane 150. The virtual projection of edge of field rays 172, including chief rays 171, converge at or near an offset NP point 192B along the optical axis 185. The NP point 192B can be quantitatively defined, for example, as the center of mass of all edge of field rays 172. An alternate offset NP point 192A can be identified, that corresponds to a “circle of least confusion”, where the paraxial, edge, and intermediate or mid-field rays, aggregate to the smallest spot (off-axis). These different “NP” points are separated from the paraxial NP point by offset distances 194A and 194B, and from each other by an offset distance 194C. Thus, it can be understood that an aggregate “NP point” for any given real imaging lens assembly or camera lens that supports a larger than paraxial FOV, or an asymmetrical FOV, is typically not a point, but instead can be an offset low parallax (LP) smudge or volume 188. The NP points for the mid field rays and the edge of field chief rays typically fall further from the image plane than does the paraxial entrance pupil or paraxial NP point, but not always. In a lens design, those details can depend on both the design specifications and the optimization priorities.

Within a smudge or low parallax volume 188, a variety of possible optimal or preferred NP points can be identified. For example, an offset NP point corresponding to the edge of field rays 172 can be emphasized, so as to help provide improved image tiling. An alternate mid-field (e.g., 0.6-0.8) NP point (not shown) can also be tracked and optimized for. Also, the size and position of the overall “LP” smudge or volume 188, or a preferred NP point (e.g., 192B) therein, can change depending on the lens design optimization. Such parameters can also vary amongst lenses, for one fabricated lens system of a given design to another, due to manufacturing differences amongst lens assemblies. Although FIG. 4C depicts these alternate offset “NP points” 192A,B for non-paraxial rays as being located after the paraxial NP point 190, or further away from the lens and image plane, other lenses of this type, optimized using the methods of the present approach, can be provided where similar non-paraxial NP points 192A,B that are located with a low parallax volume 188 can occur at positions between the image plane and the paraxial NP point.

FIG. 4C also shows a location for a center of the low-parallax multi-camera panoramic capture device, device center 196. Based on optical considerations, an improved panoramic multi-camera capture device 300 can be preferably optimized to nominally position the device center 196 within the low parallax volume 188. Optimized locations therein can include being located at or proximate either of the offset NP points 192A or 192B, or within the offset distance 194B between them, so as to prioritize parallax control for the edge of field chief rays. The actual position therein depends on parallax optimization, which can be determined by the lens optimization relative to spherical aberration of the entrance pupil, or direct chief ray constraints, or distortion, or a combination thereof. For example, whether the spherical aberration is optimized to be over corrected or under corrected, and how weightings on the field operands in the merit function are used, can affect the positioning of non-paraxial “NP” points for peripheral fields or mid fields. The “NP” point positioning can also depend on the management of fabrication tolerances and the residual variations in lens system fabrication. The device center 196 can also be located proximate to, but offset from the low parallax volume 188, by a center offset distance 198. This approach can also help tolerance management and provide more space near the device center 196 for cables, circuitry, cooling hardware, and the associated structures. In such case, the adjacent cameras 120 can then have offset low parallax volumes 188 of “NP” points (FIG. 4C), instead of coincident ones (FIGS. 4A, 4B). In this example, if the device center 196 is instead located at or proximate to the paraxial entrance pupil, NP point 190, then effectively one or more of the outer lens elements 137 of the cameras 120 are undersized and the desired full FOVs are not achievable.

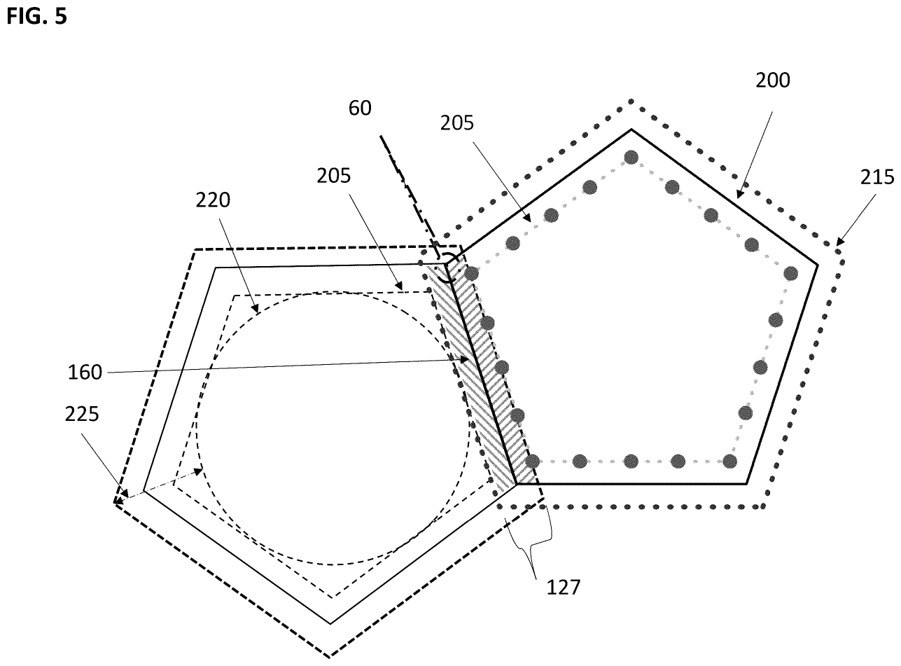

The width and location of the low parallax volume 188, and the vectoral directions of the projections of the various chief rays, and their NP point locations within a low parallax volume, can be controlled during lens optimization by a method using operands associated with a fan of chief rays 170 (e.g., FIGS. 2A,2B). But the LP smudge or LP volume 188 of FIG. 4C can also be understood as being a visualization of the transverse component of spherical aberration of the entrance pupil (PSA), and this parameter can be used in an alternate, but equivalent, design optimization method to using chief ray fans. In particular, during lens optimization, using Code V for example, the lens designer can create a special user defined function or operand for the transverse component (e.g., ray height) of spherical aberration of the entrance pupil, which can then be used in a variety of ways. For example, an operand value can be calculated as a residual sum of squares (RSS) of values across the whole FOV or across a localized field, using either uniform or non-uniform weightings on the field operands. In the latter case of localized field preferences, the values can be calculated for a location at or near the entrance pupil, or elsewhere within a low parallax volume 188, depending on the preference towards paraxial, mid, or peripheral fields. An equivalent operand can be a width of a circle of least confusion in a plane, such as the plane of offset NP point 192A or that of offset NP 192B, as shown in FIG. 4C. The optimization operand can also be calculated with a weighting to reduce or limit parallax error non-uniformly across fields, with a disproportionate weighting favoring peripheral or edge fields over mid-fields. Alternately, the optimization operand can be calculated with a weighting to provide a nominally low parallax error in a nominally uniform manner across all fields (e.g., within or across a Core FOV 205, as in FIG. 5). That type of optimization may be particularly useful for mapping type applications.

Whether the low-parallax lens design and optimization method uses operands based on chief rays or spherical aberration of the entrance pupil (PSA), the resulting data can also be analyzed relative to changes in imaging perspective. In particular, parallax errors versus field and color can also be analyzed using calculations of the Center of Perspective (COP), which is a parameter that is more directly relatable to visible image artifacts than is a low parallax volume, and which can be evaluated in image pixel errors or differences for imaging objects at two different distances from a camera system. The center of perspective error is essentially the change in a chief ray trajectory given multiple object distances-such as for an object at a close distance (3 ft), versus another at “infinity.”

Perspective works by representing the light that passes from a scene through an imaginary rectangle (realized as the plane of the illustration), to a viewer's eye, as if the viewer were looking through a window and painting what is seen directly onto the windowpane. In drawings and architecture, for illustrations with linear or point perspective, objects appear smaller as their distance from the observer increases. In a stereoscopic image capture or projection, with a pair of adjacent optical systems, perspective is a visual cue, along with dual view parallax, shadowing, and occlusion, that can provide a sense of depth. In the case of image capture by a pair of adjacent cameras with at least partially overlapping fields of view, parallax image differences are a cue for stereo image perception, or are an error for panoramic image assembly.

Analytically, the chief ray data from a real lens can also be expressed in terms of perspective error, including chromatic errors, as a function of field angle. Perspective error can then be analyzed as a position error at the image between two objects located at different distances or directions. Perspective errors can depend on the choice of COP location, the angle within the imaged FOV, and chromatic errors. For example, it can be useful to prioritize a COP so as to minimize green perspective errors. Perspective differences or parallax errors can be reduced by optimizing a chromatic axial position (Δz) or width within an LP volume 188 related to a center of perspective for one or more field angles within an imaged FOV. The center of perspective can also be graphed and analyzed as a family of curves, per color, of the Z (axial) intercept position (distance in mm) versus field angle. Alternately, to get a better idea of what a captured image will look like, the COP can be graphed and analyzed as a family of curves for a camera system, as a parallax error in image pixels, per color, versus field.

During the design or a camera lens systems, a goal can be to limit the parallax error to a few pixels or less for imaging within a Core FOV 205 (FIG. 5). Alternately, it can be preferable to particularly limit parallax errors in the peripheral fields, e.g., for the outer edges of a Core FOV and for an Extended FOV region (if provided). If the residual parallax errors for a camera are thus sufficiently small, then the parallax differences seen as a perspective error between two adjacent cameras near their shared seam 160, or within a seam related region of extended FOV overlap imaging, can likewise be limited to several pixels or less (e.g., less than or equal to 3-4 pixels). Depending on the lens design, device design, and application, it can be possible and preferable to reduce parallax errors for a lens system further, as measured by perspective error, to less than or equal to 0.5 pixel for an entire Core FOV, the peripheral fields, or both. If these residual parallax errors for each of two adjacent cameras are small enough, images can be acquired, cropped, and readily tiled, while compensating for or hiding image artifacts from any residual seams 160 or blind regions 165.

In pursuing the design of a panoramic camera of the type of that of FIG. 1, but to enable an improved low-parallax multi-camera panoramic capture device (300), having multiple adjacent cameras, the choices of lens optimization methods and parameters can be important. A camera lens 120, or system of lens elements 135, like that of FIG. 2A, can be used as a starting point. The camera lens has compressor lens element(s), and inner lens elements 140, the latter of which can also be defined as consisting of a pre-stop wide angle lens group, and a post-stop eyepiece-like lens group. In designing such lenses to reduce parallax errors, it can be valuable to consider how a fan of paraxial to non-paraxial chief rays 125 (see FIG. 2A), or a fan of edge chief rays 170 (see FIG. 2B), or localized collections of edge of field rays 172 (see FIG. 4C) are imaged by a camera lens assembly. It is possible to optimize the lens design by using a set of merit function operands for a collection or set (e.g., 31 defined rays) of chief rays, but the optimization process can then become cumbersome. As an alternative, in pursuing the design of an improved low-parallax multi-camera panoramic capture device (300), it was determined that improved performance can also be obtained by using a reduced set of ray parameters or operands that emphasizes the transverse component of spherical aberration at the entrance pupil, or at a similar selected surface or location (e.g., at an offset NP point 192A or 192B) within an LP smudge volume 188 behind the lens system. Optimization for a transverse component of spherical aberration (PSA) at an alternate non-paraxial entrance pupil can be accomplished by using merit function weightings that emphasize the non-paraxial chief rays.

As another aspect, in a low-parallax multi-camera panoramic capture device, the fans of chief rays 170 that are incident at or near a beveled edge of an outer lens element of a camera 120 (see FIG. 2B) should be parallel to a fan of chief rays 170 that are incident at or near an edge 132 of a beveled surface of the outer lens element of an adjacent camera (see FIG. 1). It is noted that an “edge” of an outer lens element 137 or compressor lens is a 3-dimensional structure (see FIG. 2B), that can have a flat edge cut through a glass thickness, and which is subject to fabrication tolerances of that lens element, the entire lens assembly, and housing 130, and the adjacent seam 160 and its structures. The positional definition of where the beveled edges are cut into the outer lens element depends on factors including the material properties, front color, distortion, parallax correction, tolerances, and an extent of any extra extended FOV 215. An outer lens element 137 becomes a faceted outer lens element when beveled edges 132 are cut into the lens, creating a set of polygonal shaped edges that nominally follow a polygonal pattern (e.g., pentagonal, or hexagonal). Throughout this specification, the terms “polygonal shaped edges,” “polygonal edges,” “polygonal shaped lens edges,” and similar terms may be used to refer to one or more edges of a polygonal-shaped lens configured to image a polygonal-shaped field of view, e.g., as a polygon-shaped image corresponding to the field of view, as discussed above.

As another aspect, FIG. 4E depicts “front color.” which is a difference in the nominal ray paths by color versus field, as directed to an off axis or edge field point. Typically, for a given field point, the blue light rays are the furthest offset. As shown in FIG. 4E, the accepted blue ray 157 on a first lens element 137 is ΔX≈1 mm further out than the accepted red ray 158 directed to the same image field point. If the lens element 137 is not large enough, then this blue light can be clipped or vignetted, and a color shading artifact can occur at or near the edges of the imaged field. Front color can appear in captured image content as a narrow rainbow-like outline of the polygonal FOV or the polygonal edge of an outer compressor lens element which acts as a field stop for the optical system. Localized color transmission differences that can cause front color related color shading artifacts near the image edges can be caused by differential vignetting at the beveled edges of the outer compressor lens element 137, or from edge truncation at compressor lens elements, or through the aperture stop 145. During lens design optimization to provide an improved camera lens (320), front color can be reduced (e.g., to ΔX (B-R) less than or equal to 0.5 mm width) as part of the chromatic correction of the lens design, including by glass selection within the compressor lens group or the entire lens design, or as a trade-off in the correction of lateral color. The effect of front color on captured images can also be reduced optomechanically, by designing an improved camera lens (320) to have an extended FOV 215 (FIG. 5), and also the opto-mechanics to push straight cut or beveled lens edges 132 at or beyond the edge of the extended FOV 215, so that any residual front color occurs outside the core FOV 220. Any residual front color artifact can then be eliminated during an image cropping step during image processing.

FIG. 4D depicts a variation of center of perspective 280, as an error or difference in image pixels versus field angle and color (R, G, B) for a low-parallax lens of the type of FIGS. 2A and 2B, but with an improved optical design and performance. In this example, imaging of two objects, one at a 3-foot distance from an improved low-parallax multi-camera panoramic capture device (300) having improved low-parallax camera lenses 320 and the other object at an “infinite” (∞) distance from the device, were analyzed. FIG. 4D shows parallax errors of <1 pixel for red and green, and ˜1.5 pixels in blue, from on axis, to nearly the edge of the field (e.g., to ˜34 deg.). Parallax errors can also be quantified in angles (e.g., fractions of a degree per color). Although the R,G,B curves of center of perspective difference 280 have similar shapes due to parallax optimization, there are small offset and slope differences between them. These differences are expressions of residual chromatic differences in the lens, including lateral color, axial color, and front color. The parallax errors for blue light can exceed 1.5 pixels out at the extreme field points (e.g., the vertices). However, limiting perspective or parallax errors further, to sub-pixel levels (e.g., less than or equal to 0.5 pixel) for imaging within the designed FOVs, and particularly within the peripheral fields, for at least green light, is preferable. If the residual parallax errors between adjacent cameras are small enough, the captured images obtained from the core FOVs can be readily and quickly cropped and tiled together. Likewise, if the residual parallax errors within the extended FOVs that capture content in or near the seams are similarly small enough, and the two adjacent cameras are appropriately aligned to one another, then the overlapped captured image content by the two cameras can be quickly cropped or averaged and included in the output panoramic images.

Optical performance at or near the seams can also be understood, in part, relative to a set of defined fields of view (FIG. 5). In particular, FIG. 5 depicts potential sets of fields of view for which potential image light can be collected by two adjacent cameras. As an example, a camera with a pentagonal shaped outer lens element, whether associated with a dodecahedron or truncated icosahedron or other polygonal lens camera assembly, with a scam 160 separating it from an adjacent lens or camera channel, can image an ideal FOV 200 that extends out to the vertices (60) or to the polygonal edges of the frustum or conical volume that the lens resides in. However, because of the various physical limitations that can occur at the seams, including the finite thicknesses of the lens housings, the physical aspects of the beveled lens element edges, mechanical wedge, and tolerances, a smaller core FOV 205 of transiting image light can actually be imaged. The coated clear aperture for the outer lens elements 137 should encompass at least the core FOV 205 with some margin (e.g., 0.5-1.0 mm). As the lens can be fabricated with AR coatings before beveling, the coatings can extend out to the seams. The core FOV 205 can be defined as the largest low parallax field of view that a given real camera 120 can image. Equivalently, the core FOV 205 can be defined as the sub-FOV of a camera channel whose boundaries are nominally parallel to the boundaries of its polygonal cone (see FIGS. 4A and 4B). Ideally, with small seams 160, and proper control and calibration of FOV pointing, the nominal Core FOV 205 approaches or matches the ideal FOV 200 in size.

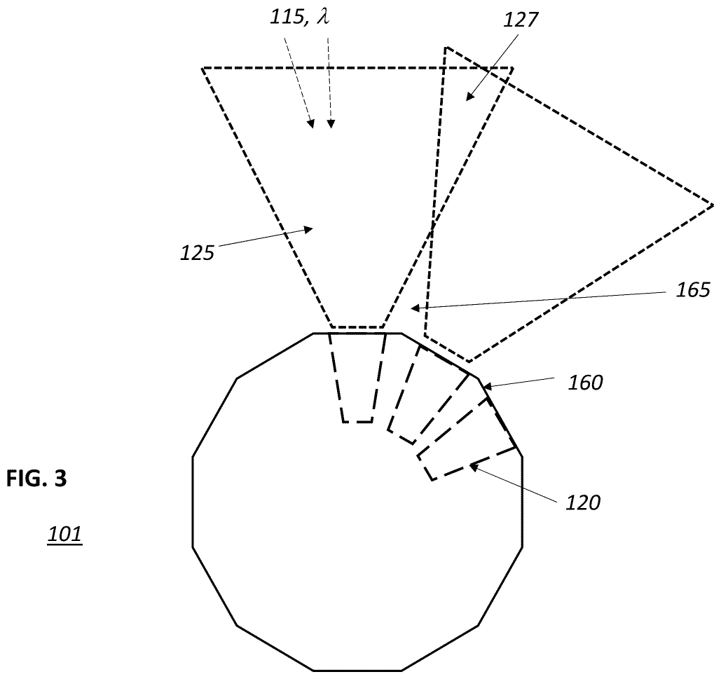

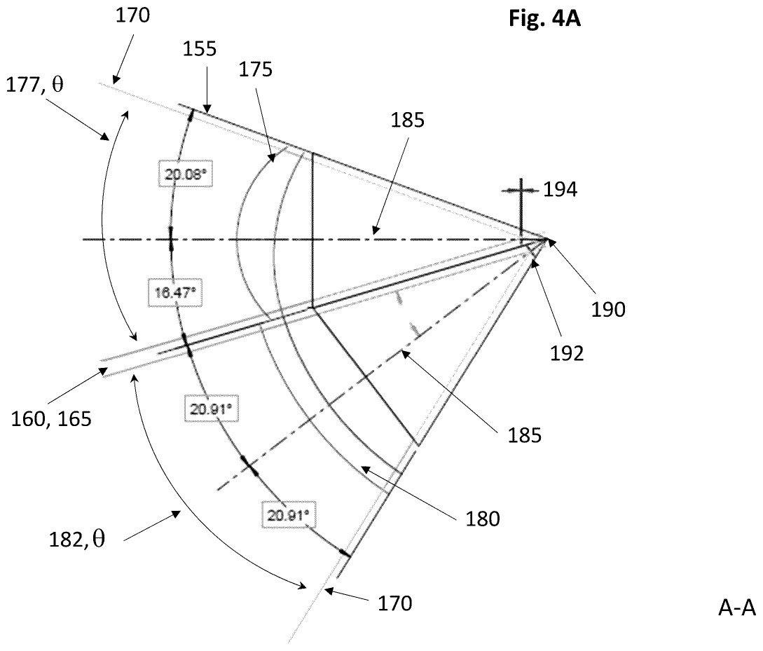

To compensate for the blind regions 165, and the associated loss of image content from a scene, the cameras can be designed to support an extended FOV 215, which can provide enough extra FOV to account for the seam width and tolerances, or an offset device center 196. As shown in FIG. 5, the extended FOV 215 can extend far enough to provide overlap 127 with an edge of the core FOV 205 of an adjacent camera, although the extended FOVs 215 can be larger yet. This limited image overlap can result in a modest amount of image resolution loss, parallax errors, and some complications in image processing as were previously discussed with respect to FIG. 3, but it can also help reduce the apparent width of scams and blind regions. However, if the extra overlap FOV is modest (e.g., less than or equal to 5%) and the residual parallax errors therein are small enough (e.g. less than or equal to 0.75-pixel perspective error), as provided by the present approach, then the image processing burden can be very modest. Image capture out to an extended FOV 215 can also be used to enable an interim capture step that supports camera calibration and image corrections during the operation of an improved panoramic multi-camera capture device 300. FIG. 5 also shows an inscribed circle within one of the FOV sets, corresponding to a subset of the core FOV 205, that is the common core FOV 220 that can be captured in all directions from that camera. The angular width of the common core FOV 220 can be useful as a quick reference for the image capacity of a camera. An alternate definition of the common core FOV 220 that is larger, to include the entire core FOV 205, can also be useful. The dashed line (225) extending from the common core FOV 220 or core FOV 205, to beyond the ideal FOV 200, to nominally include the extended FOV 215, represents a region in which the lens design can support careful mapping of the chief or principal rays or control of spherical aberration of the entrance pupil, so as to enable low-parallax error imaging and easy tiling of images captured by adjacent cameras.

Across a seam 160 spanning the distance between two adjacent usable clear apertures between two adjacent cameras, to reduce parallax and improve image tiling, it can be advantageous if the image light is captured with substantial straightness, parallelism, and common spacing over a finite distance. The amount of extended FOV that is designed in can account for the expected optical and mechanical seam widths and the nominal object viewing distance. For example, a finite mechanical seam width can require less extended FOV to cover the seams if the imaged objects are always distant from the multi-camera device. In general, the mechanical seam widths are less than or equal to 8 mm, and are preferably less than or equal to 4 mm. The amount of FOV overlap needed to provide an extended FOV and limit blind regions can be determined by controlling the relative proximity of the entrance pupil (paraxial NP point) or an alternate preferred plane within a low parallax volume 188 (e.g., to emphasize peripheral rays) to the device center 196 (e.g., to the center of a dodecahedral shape). The amount of Extended FOV 215 is preferably 5% or less (e.g., less than or equal to 1.8° additional field for a nominal Core FOV of) 37.5°, such that a camera's peripheral fields are then, for example, ˜0.85-1.05). If spacing constraints at the device center, and fabrication tolerances, are well managed, the extended FOV 215 can be reduced to less than or equal to 1% additional field. Within an extended FOV 215, parallax should be limited to the nominal system levels, while both image resolution and relative illumination remain satisfactory. The parallax optimization to reduce parallax errors can use either chief ray or pupil aberration constraints, and targeting optimization for a high FOV region (e.g., 0.85-1.0 field), or beyond that to include the extra camera overlap regions provided by an extended FOV 215 (e.g., FIG. 5, a fractional field range of ˜0.85-1.05).

Given the problems that front color (e.g., FIG. 4E) can cause, it can be advantageous to develop improved design methods and to reduce the magnitude further (e.g., to less than or equal to 0.2 mm and preferably to less than or equal to 0.1 mm). Front color is seen at or near the polygonal edges of the image at the image plane, but it is caused by chromatic aberration of the entrance pupil that manifests as spatial color or beam height differences for red, green, and blue light at the outer compressor lens element. The outer compressor lens element and its polygonal edges essentially act as a soft or unfocused field stop. As the incoming light from near the polygonal edges propagates through the lens, blue light traverses an outer path relative to green and red, and can be vignetted unless the designer is careful in defining the clear apertures. Whereas, red light traverses an inwards path relative to green and blue, and comparatively is not attenuated. This results in a rainbow image plane artifact with retained red light lying along the outer edge, adjacent to green, and blue light further inwards, before the internal lens fields or Core FOV with normal white light transmission are reached. Additionally, this front color problem means that the distance between adjacent camera channels must increase. These gaps are unwanted and thus minimizing front color is important.

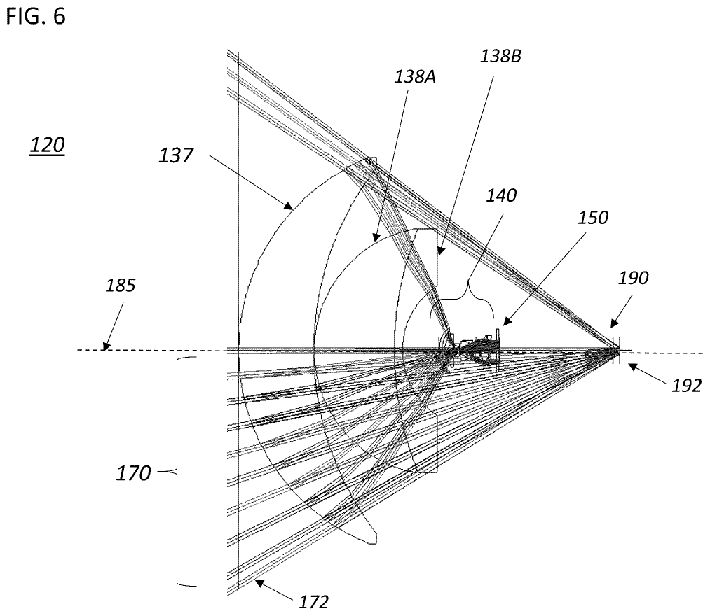

During the design of low-parallax camera or objective lens systems, front color has been hard to control. The problem starts as soon as incident light is refracted from the first compressor element. Thus, a low dispersion element should be used. At the same time, to minimize curvature on this large element, the highest possible index should also be used. These conflicting pressures can drive the selection of an optical material such as OHARA S-LAH53 that resides in the upper left corner of the glass map. However, the glass selection in this region of the glass map is rather limited. Improved solutions can be found by using a non-traditional optical material for the front lens element, such as the optical ceramic, ALON, from Surmet (Burlington, MA). However, it may be undesirable to have such a large element made from this material. ALON has a similar index to S-LAH53, but with much lower dispersion. To compensate for using the S-LAH53 front element, a doublet L2-3 was added (see the objective lens in FIG. 1) to obtain a three-element compressor group with the doublet helping to correcting residual color problems and thus enable reduction of front color. Such an example low-parallax and low front color camera lens 120 is depicted in FIG. 6, in which the outer compressor element 137 uses SLAH-53 and the inner compressor lens elements 138, use SBAH 28 for element 138A and STIH53 for element 138B, all from Ohara Glass, respectively. However, the design is further complicated by the simultaneous requirements that the three compressor elements must also provide a very small entrance pupil spherical aberration (PSA) to control or limit parallax. Moreover, at the same time, the entire lens system must produce low lateral color (LC) and distortion aberrations at the image.

During the design of a low parallax camera or objective lens system, as in FIG. 1 or FIG. 6, it can be difficult to simultaneously achieve the three objectives of low parallax, low front color, and low lateral color. Typically, front color and lateral color are inversely related, and reducing one increases the other. In lens designs for low-parallax lenses supporting a dodecahedral geometry, in which the individual camera channels support a maximum half FOV of ˜37.4 degrees, a three-element compressor lens group does not seem to have enough degrees of freedom, and a compromise value of 0.4-0.6 mm of front color (as measured on the outer compressor lens element) can be left. But in reality, a smaller residual front color value for Blue to red separation, of less than or equal to 0.1 mm width, is preferable.

One method to fix this, as previously mentioned, is to use a non-traditional optical material, such as ALON. It was noticed that the preferred glasses for several lens elements amongst the inner lens elements 140 are in the upper left corner of the glass map. Using ALON for these much smaller elements can be beneficial. As another alternative, lateral color can be allowed to increase. But it can readily hit unacceptable values, equivalent to several image pixels. As a third alternative, when an objective lens is paired with a relay imaging system, the lateral color of the objective lens can be sacrificed to allow front color to be reduced. This means that lateral color at the first or primary aerial image can be “unacceptably” large, but the relay system fixes the final performance loss at the final image. In this case, optimization of pupil spherical aberration (PSA) and front color is controlled by the compressor lens group of the objective lens, resulting in performance loss (e.g., lateral color, distortion, and telecentricity) at the first or intermediate image, that is then compensated for in the relay lens design. Advantageously, the imaging relay doesn't experience any of the space constraints found in the objective lens. But the application must allow use or space for an objective lens and relay lens system combination in at least one imaging channel of a panoramic multi-camera device.

As one approach to simplifying these lens systems, it can be desirable to replace the optical materials used for the large front compressor lens elements from glass to plastic. However, the current and historic optical plastics or polymers are very limited, and there are not high index, low dispersion materials that are near equivalent to S-LAH 53 or ALON. Cemented plastic doublets may also be undesirable, particularly with lens elements of the size of the compressor lens elements.

To overcome these problems, a new enhanced approach or method was developed for designing low parallax lenses with better simultaneous parallax and front color performance. This improved approach applies to lenses having refractive compressor lens elements using glass, plastic or polymer materials, optical ceramics, or combinations thereof. It also applies to lenses using lens elements having free-form surfaces, or surfaces with sub-wavelength or metamaterial structures.

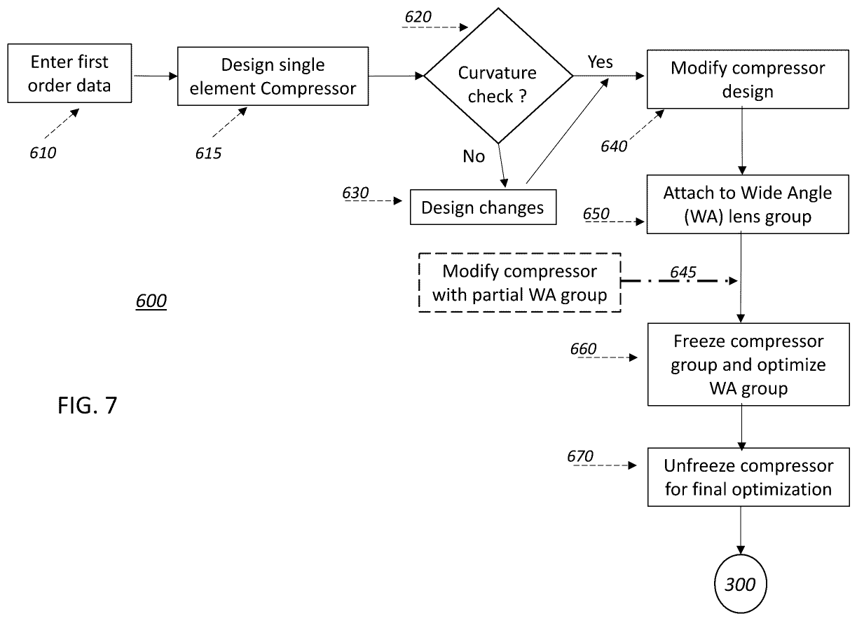

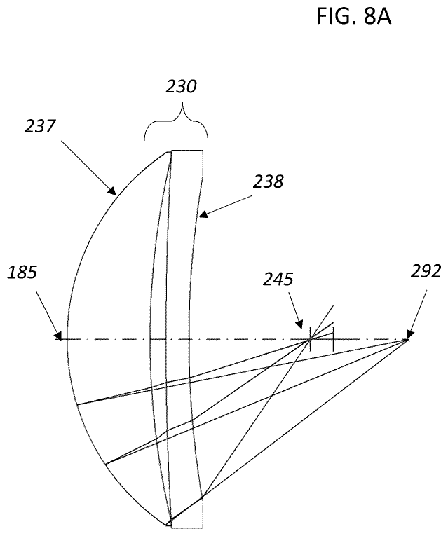

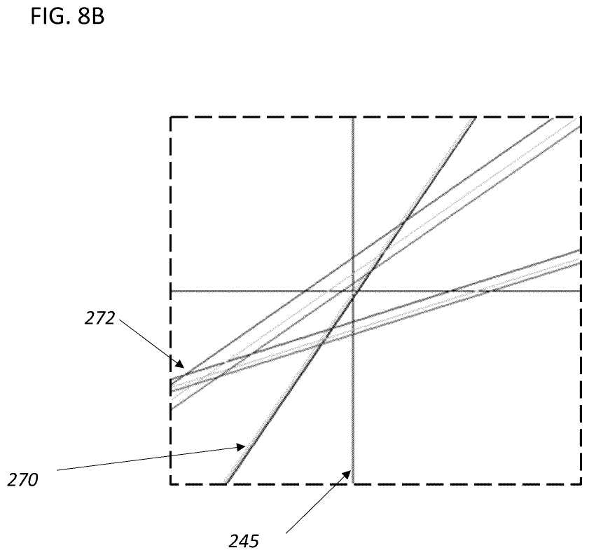

As one embodiment to this new approach, a new lens design method 600, illustrated in FIG. 7, can be used in which a lens system is designed by isolating the compressor lens elements or lens group, and designing them first (steps 610-640), and then combining (step 650) the compressor lenses with other lens elements, to design (steps 660-670) a complete low parallax, low front color camera or objective lens system 300. In greater detail, in step 610, first order target data, such as a focal length and spectral operating bandwidth, is provided for a first compressor lens element 237 (see FIG. 8A). In particular, first order data for the position of the aperture stop, the position of the entrance pupil, the field angles for the compressor and for the wide-angle group can be based on, guessed at, or derived from, either overall system specifications or from prior designs for this type of lens system.

Also, as an initial approach, the initial first order data provided in step 610 can temporarily limit the spectrum to a quasi-monochromatic wavelength band (e.g., in the green with a 20 nm bandwidth). This temporarily removes front color, lateral color, and any other color aberrations. Then during an initial compressor optimization step 615, a first compressor lens element 237 can be designed in terms of shape and size so as to direct incident light towards a temporary aperture stop 292 that is also an un-aberrated entrance pupil, located near the location for the final LP-smudge, and the chief rays converge towards a location 245 that nominally corresponds to where the final aperture stop of the complete lens would be located. Of course it is possible to switch the roles of 245 and 292 because they are conjugate to each other. During the initial compressor optimization step 615, essentially a single lens element monochromatic compressor with acceptable PSA is being designed. This compressor can be designed in isolation or while including some or all of the pre-stop elements from the wide-angle lens group (140), if available. In the latter case, it is useful or preferred if the prescriptions for the wide-angle lens elements are frozen or fixed during this pre-stop, compressor lens group design phase (steps 610-640).

During this initial compressor optimization step 615, the lens position, size, bending, and power of the first compressor lens element 237 can be found to solve all the monochromatic aberrations. This first lens element typically has a shape like that of the first lens element 237 depicted in FIG. 8A, but with an even more meniscus shape, and it can provide very low pupil spherical aberration (PSA), which is coming from a specific shape factor of the single compressor element. There are a variety of ways to set up this lens and perform non-imaging optimization while using the improved lens design method 600 of FIG. 7. If this first compressor lens element 237 is too extreme in shape to be manufactured or robustly mounted, per curvature check step 620, the design can be changed per design changes step 630, for example, to reduce the element curvature(s). In step 630, the lens curvature is corrected, and if it is deemed acceptable, the design process can move on to color correction step 640. For example, to provide a less extreme shaped compressor lens element 237, the optical material, glass, plastic, or ceramic, can be changed to a higher refractive index material. The design bandwidth can also be expanded (e.g., to 50 nm). Alternately, or in addition, the compressor lens group can be expanded to include both first and second compressor lens elements 237 and 238. This front group of compressor lens elements 230 does not produce a proper image of an object and thus optimization is set to satisfy lens designer defined internal constraints only.

But in recognition of the expectation that color correction will eventually be required, particularly in the visible light spectrum, a compressor lens group 230 with at least two compressor lens elements 237 and 238, such as those depicted in FIG. 8A, may be needed. Then in step 640, the compressor lens group design can be further modified via optical material selections to further expand the design spectral bandwidth (e.g., to 200-300 nm) and to achromatize this doublet. To accomplish the achromatization, the lens materials (e.g., index and dispersion) are selected, and the lens element bending, or curvatures, thicknesses, and intervening spaces are designed to direct the light of a given field forwards with minimal spectral or color differences in the position and vectorial direction of these light rays when exiting the achromatized lens group. Optimization during step 640 can also provide both good control of the pupil spherical aberration (PSA) and the axial chromatic pupil aberration by optimization of the two-element compressor group alone. During the modify compressor design step 640, the design spectrum can be expanded to span the intended full wavelength range while correcting for front color. A third or flint lens element can be added if necessary. During design step 640, first order compressor design targets, and the design itself, may also be modified if necessary. Design steps 610-640 are a non-imaging optimization for this isolated lens element group (230). Controlling the axial chromatic pupil aberration essentially achromatically corrects the entrance pupil spherical aberration and is an effective mechanism for controlling front color.

In designing lenses using the new method 600, and particularly the achromatic correction thereof, a goal is that in correcting parallax and front color, that projections of chief rays for light at or near the low end and high end of the imaged spectral bandwidth fall nominally into the same small low-parallax volume or LP smudge. For a color corrected imaging system having a 200 nm wide spectral bandwidth, the low end and high-end wavelengths or colors can, for example, be at 450 nm and 650 nm. Whereas, for a color corrected system imaging a 300 nm wide spectral bandwidth, the low end and high-end wavelengths or colors can, for example, be at 400 nm and 700 nm. As another example, for a system imaging and spectrally corrected for LWIR light, the imaged and corrected spectral bandwidth can be 6 μm wide, with the low end and high-end wavelengths at 8 μm and 14 μm respectively.

As an example, in one design, the first and second compressor lens elements of FIG. 8A may include two optical plastics, the low index E48R and the higher index OKPA2, respectively. FIG. 8B depicts the chief ray color spread near the final aperture stop 245, with the edge chief rays 270 tightly controlled, and inner chief rays 272 more offset from one another. The temporary aperture stop 292 and LP-smudge 285 reverse roles in this isolated lens design process (steps 610-640), and the entrance pupil becomes virtual and aberrated as opposed to real and un-aberrated. The contributions of these compressor lens elements 237 and 238 to other optical aberrations may increase, as these lens elements have been designed with little or no emphasis thereto. Note that the color spread of the edge chief rays 270 at or near full field is very small, meaning that front color is well controlled. However, the color spread at lower fields (chief rays 272) is not corrected, and does not need to be corrected in the compressor lens element group.

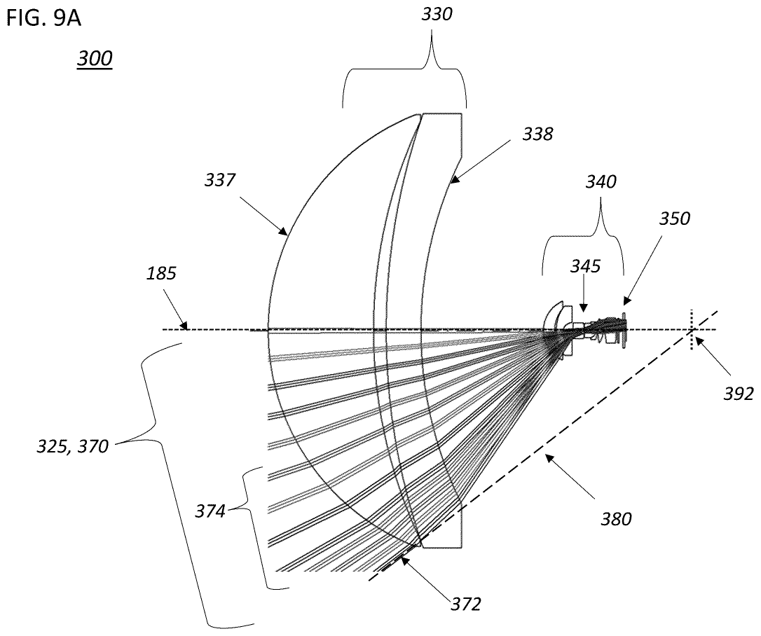

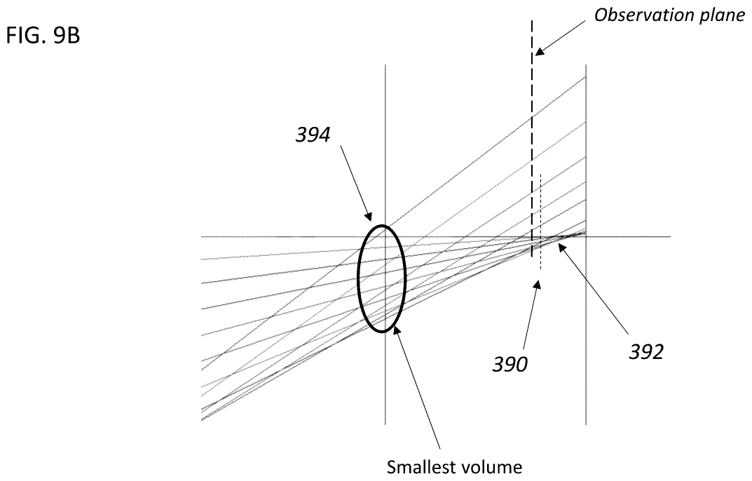

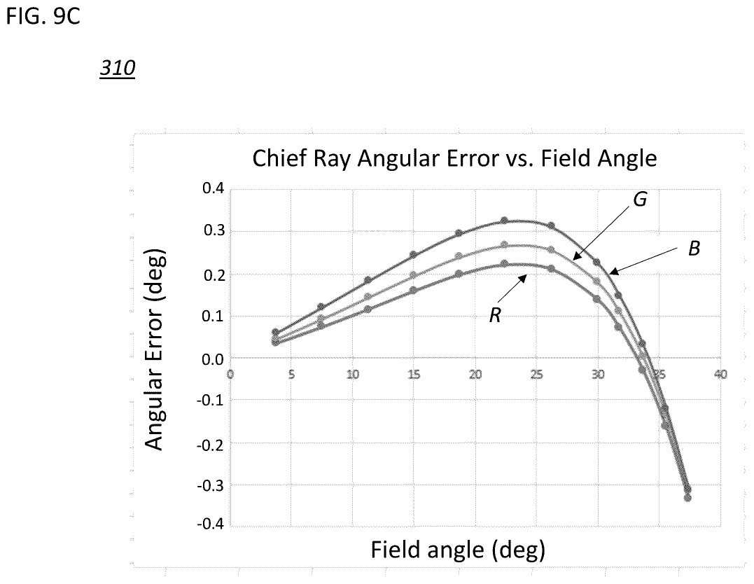

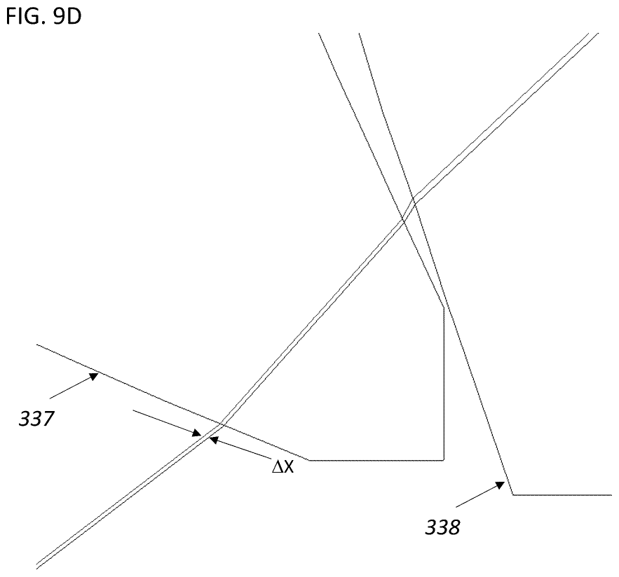

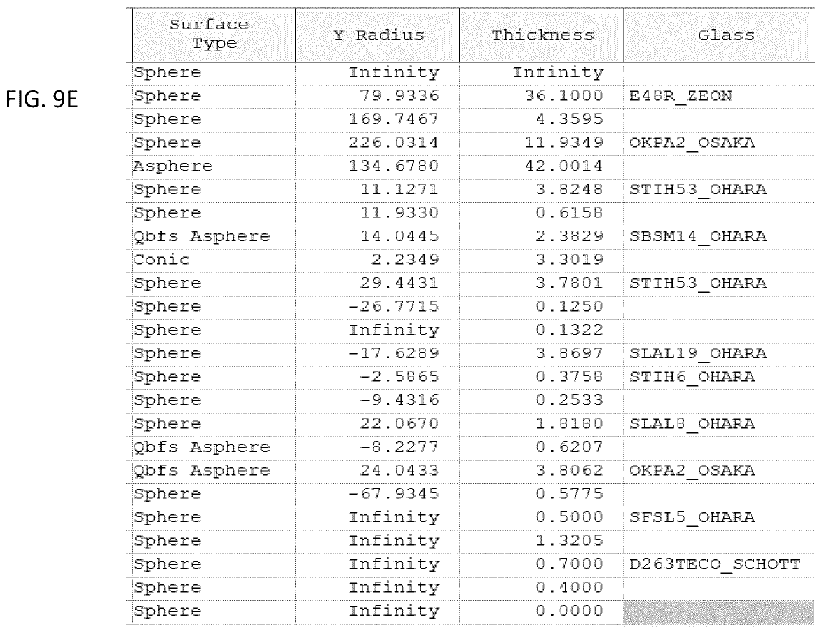

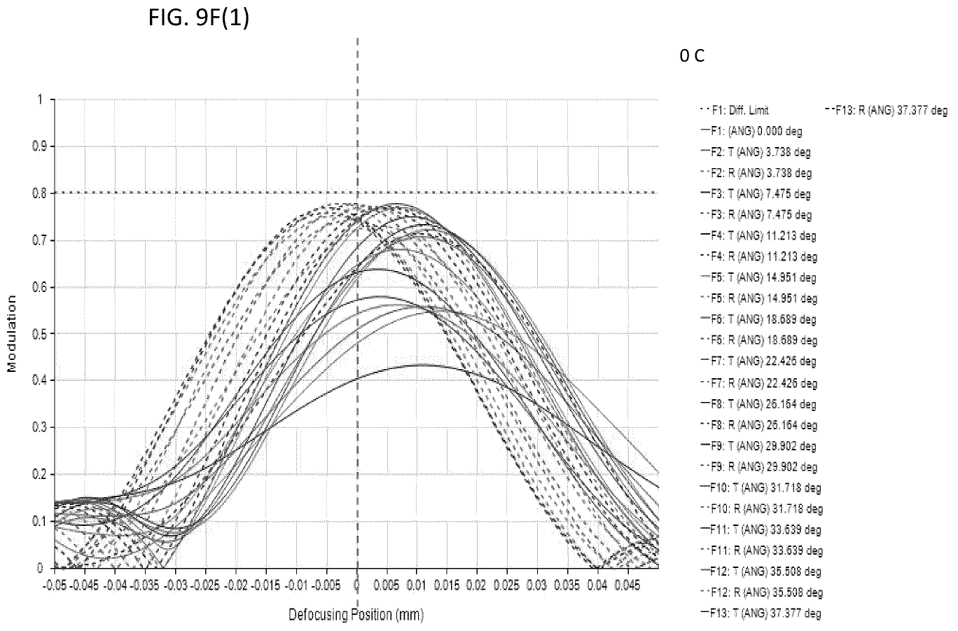

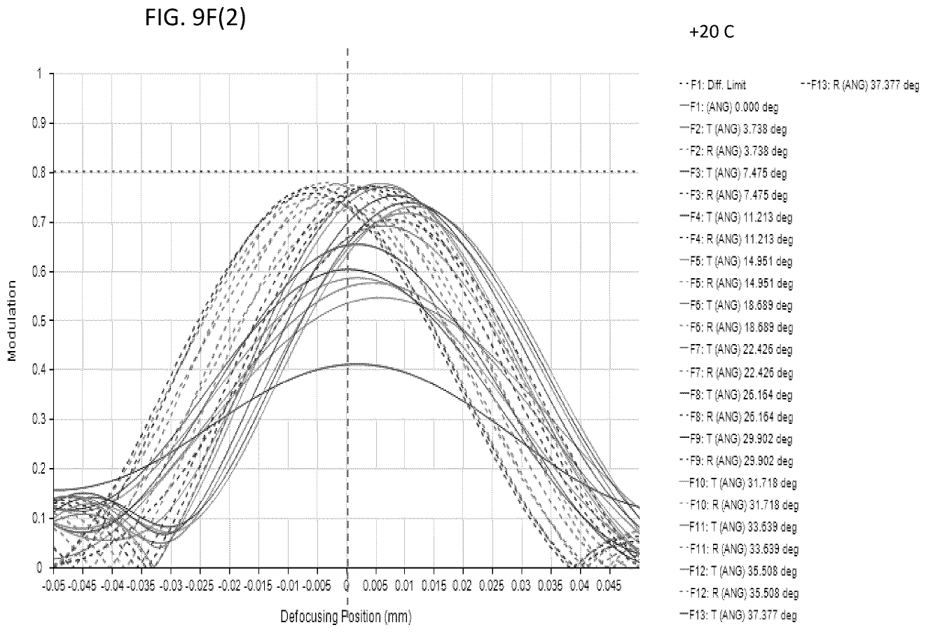

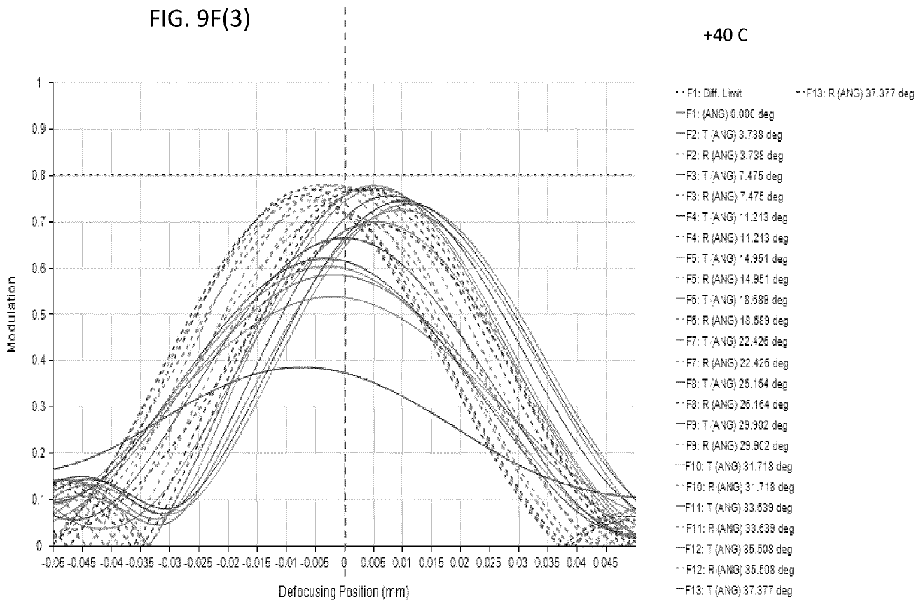

To then optimize the entire objective lens for imaging, the optimized compressor group 230 is combined (step 650) with lens elements that include or comprise the wide-angle group or inner lens elements. Considering now the complete lens of FIG. 9A, in adding the lens elements of the wide-angle group 340, the aperture stop 345 will shift along the optical axis 185, back towards its original location in the lens further from the vertex of the first compressor lens element, but the projected paraxial entrance pupil and non-paraxial equivalents will remain in the same nominal location as the original lens in FIG. 8A. But adjustments may then be needed to make sure the image plane is far enough in front of the entrance pupil and LP smudge locations so that the image plane or sensor package stays within the allowed conical volume or frustum. These other lens groups are then designed (step 660) to provide the desired imaging functionality and image quality, including, in part to fix the optical aberrations introduced by the compressor group, including lateral color and distortion. The compressor lens elements can be frozen e.g., left unchanged) during this lens design optimization step (660). With the much larger number of elements, and lens surfaces with aspheric profiles, within these lens groups, good image quality can be obtained at the image plane. During a final full lens optimization step 670, the designs of the compressor lens element(s) can be allowed some freedom to change to assist the imaging design efforts, as long as the front color and parallax performance are not significantly sacrificed. FIG. 9A depicts an exemplary low parallax objective or camera lens of this type designed for a dodecahedral device. But in actuality, using this lens design method 600, new low-parallax lens designs have been achieved with equivalent or superior low residual parallax performance to prior designs, but with both improved front color and improved lateral color performance, while using standard optical glass or polymer materials.

The improved lens design method 600 of FIG. 7 can be modified in accordance with the design problem, or with increasing experience of a lens designer in designing low-parallax, low front color lenses of this type. For example, in some circumstances where the target wavelength band is limited or the available optical materials have low enough dispersion, the resulting lens design can have a compressor lens group with a single lens element, instead of having a doublet (e.g., FIG. 9A) or three or more lens elements.

In particular, FIG. 9A depicts an improved low-parallax, low front color camera lens or objective lens 300, designed per the improved method 600 and usable in a multi-camera capture device 100. This lens is designed for a dodecahedral system and thus supports polygonal edges that have field edge angles ranging from ˜31-37 degrees from mid edge to vertex. Lens system 300 images light collected from a field of view 325, including chief rays 370 and edge of field chief rays 372, through a compressor lens group 330 and inner lens elements or wide-angle group 340, and aperture stop 345 to an image plane 350. The inner lens elements or wide-angle group 340 can also be considered as a pre-stop wide angle lens group, and a post-stop eyepiece-like lens group. A virtual projection 380 of the edge chief rays 372 points towards an edge chief ray NP point 392, located behind image plane 350.

In greater detail, FIG. 9B depicts a cross sectional view of an LP smudge volume at or near the edge chief ray NP point 394 for the lens of FIG. 9A. The paraxial entrance pupil 390 is located about 26.7 mm behind the sensor or image plane 350. This diagram shows that the peripheral chief rays along the polygonal edge converge in a volume or non-paraxial NP point 394 that is offset from, but near the paraxial entrance pupil 390. The low and mid field rays converge to 392. The tight projected convergence of the peripheral chief rays is needed to reduce parallax. In this example, the projections of many mid field chief rays 374 actually converge at or near a location or mid field NP point 392 after the paraxial entrance pupil 390, but closer to it than does peripheral ray NP Point 394. But, in this design example, the projected chief rays are all contained in a smallest volume located near the edge chief ray field NP point 394. As illustrated by this example, in analyzing parallax correction, it can be useful to consider various cases.

It can also be useful to define an observation plane, and then graph residual parallax errors across that plane. As shown, the low angle (less than or equal to 10 deg.) and mid angle (e.g., 10-25 deg.) chief rays converge in a tight area that is in front of a selected observation plane. The lowest angle rays converge to a location very close to the paraxial entrance pupil and the chosen observation plane. Rays along the polygonal edges converge to points before or beyond the observation plane. This introduces some residual parallax error that is quantified in FIG. 9C, as chief ray angular error versus field angle. The position of the observation or evaluation plane shown in FIG. 9B was adjusted by a small amount to produce a balanced result for the green chief ray. This example graph of residual parallax 310 is given as an angular error versus field angle, and numerically shows a maximum residual ±0.3 degrees difference over a half field of view spanning 0-37.4 degrees.

In greater detail, in this example, true non-parallax occurs near the mid-chord point along a polygonal edge (0.0 degrees error at 33.6 degrees). The residual deviations from true non-parallax are roughly balanced about the mid-chord point, with −0.3 deg. Chief ray deviation at the vertex (37 degrees) and +0.18 degrees deviation at the mid edge (31.4 degrees) and +0.27 degrees residual error at mid field (˜24 degrees). Depending on the lens design, the magnitudes of the residual non-parallax, and the curve shapes, can vary or be further optimized. As parallax differences between adjacent cameras in stereo camera systems or in typical multi-camera panoramic systems are typically measured in degrees (e.g., 5-20 degrees), and these values are ˜100× lower, parallax related image artifacts can be substantially reduced. Other similar graphs can be created by recalculating this data in different terms. For example, a graph of residual parallax error in pixels versus position along the image plane can also be very useful.

In the FIG. 9A lens design example, front color, as measured on the outer compressor lens element 337, as measured as the local distance Dx between red and blue rays, was reduced to only 0.084 mm, as depicted in FIG. 9D. The local distance between green and blue rays is essentially zero. This is small as compared to an estimated geometric beam size on the first compressor lens element 337, of 2.2 mm. Because the lens design substantially controls front color, the three curves for RGB residual parallax in FIG. 9C substantially fall on top of each other over the extent of the polygonal edge. In particular, the graph of FIG. 9C shows a parallax measurement that indicates that the spectrally or RGB color corrected projections 380 of the chief rays, over the polygonal edge that corresponds to the ˜31-37-degree field angles from mid edge to vertex, are well corrected. In FIG. 9C this shown by the RGB curves being tightly clustered or almost overlaid (e.g., within less than or equal to 0.07 degrees of each other) over the 31-37-degree field angles that lie along a polygonal edge.

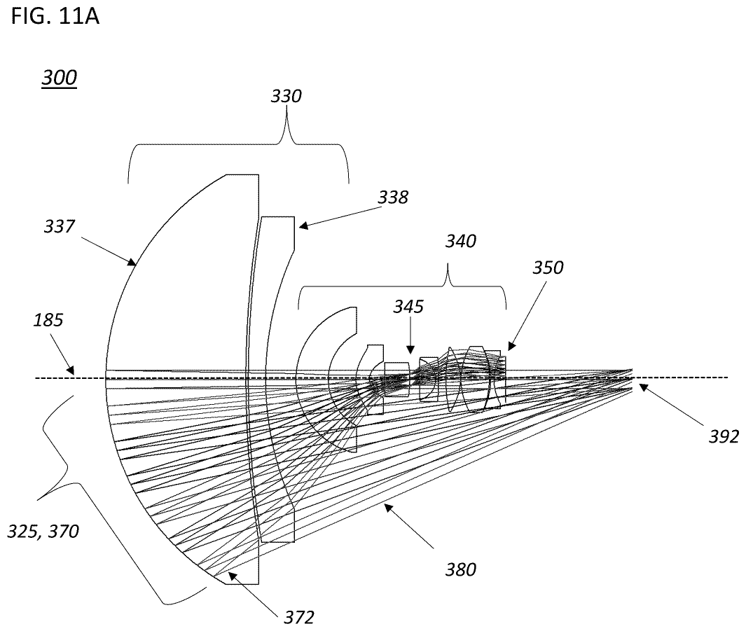

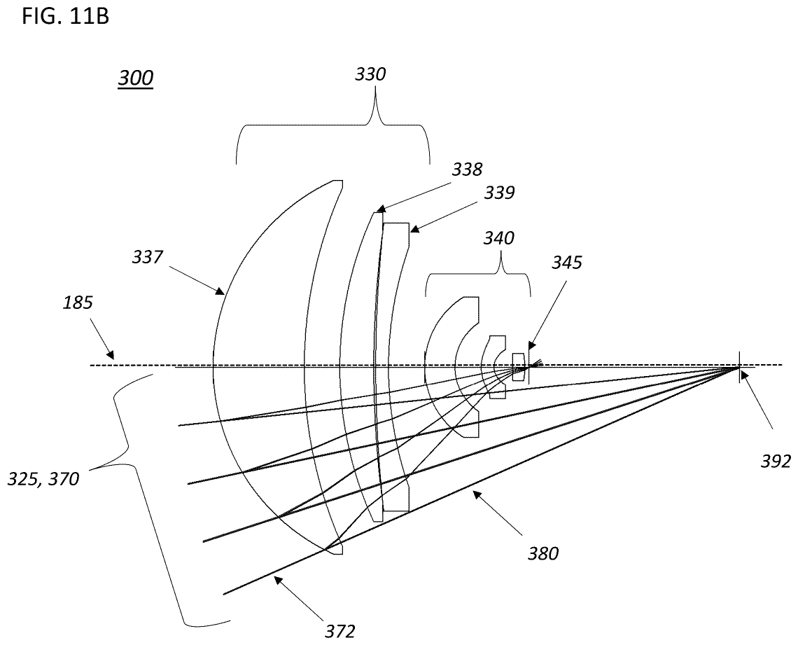

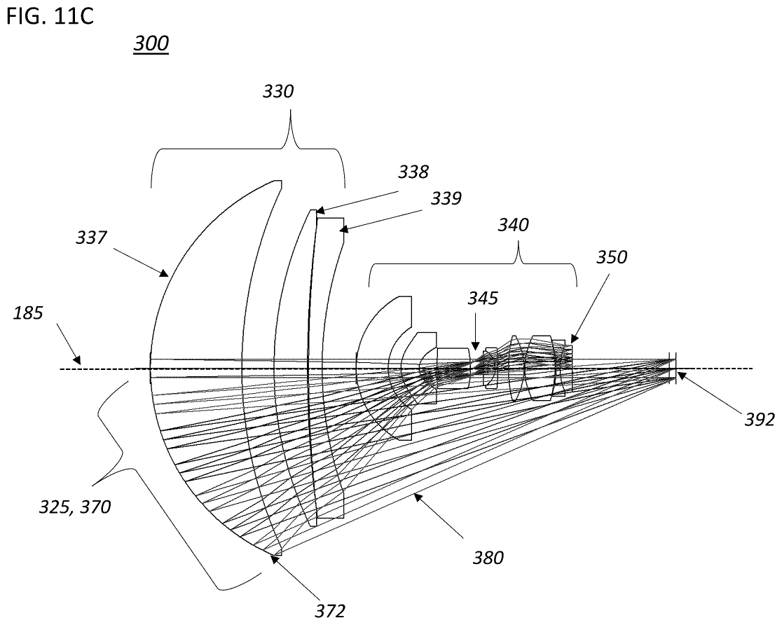

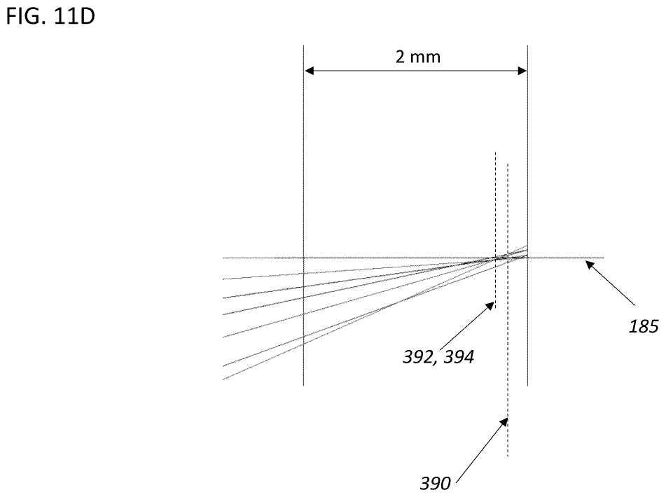

Image resolution at the sensor (pixels or pixels/mm) can also be recast into object space as pixels/degree. Typically, these low parallax lenses can support resolutions of 20-400 px/deg., depending on the design and the sensor used, although higher and lower values are possible. While adjacent chief rays for adjacent pixels are angularly offset, the geometric beam sizes overlap. Thus, the residual front color along the polygonal lens edges can correlate to an impact on multiple image pixels at the sensor. That in turn can impact the total imaged FOV, image tiling, and residual image artifacts along the polygonal edges. Thus, reducing the magnitude of front color, by the present improved design method 600 of FIG. 7, and as exemplified by the present examples of FIGS. 9A-F and FIGS. 11B-D, to 0.084 mm or 0.2 mm on the outer lens surface respectively, can translate into minimal nominal impact at the image plane. In particular, when considered at the image plane, such small angular differences can translate to a front color image artifact of less than or equal to 0.7 pixel, and preferably less than or equal to 0.2 pixels width, making the front color rainbow image artifact nearly invisible. This residual can then be readily cropped out if need be. Of course, the translation of the residual angular chief errors into image pixels at the image plane also depends on the resolution and pixel size of the image sensor. So, that scale, while quite useful, can also be relative.

Taken together, FIG. 9C and FIG. 9D are an indication that this example lens design, which was created by applying the improved lens design method 600 of FIG. 7, has very little residual color difference to both front color and the perspective or parallax correction. The amount of residual parallax error and residual front color can contribute to design choices about how much extended FOV 215 is provided beyond the Core FOV 205. The improved front color performance is also helpful as it helps the opto-mechanical design reduce the seam widths and avoid differential color vignetting near polygonal edges of the compressor lens(es).

FIG. 9E shows the optical prescription for the example low parallax, low front color, imaging lens 300 of FIG. 9A. It consists of 9 lens elements, as well as a filter plate and a detector window near the image plane. Element 1 uses optical plastic E48R, while lens elements 2 and 9 are both designed with optical plastic OKPA2. Element 4 has an aspheric and a conic surface. Lens elements 8-9 have one aspheric surface each. The entire imaging lens has a focal length of 4.87 mm and an aperture of f/2.8. Its half field of view is 37.4° and it supports an image semi-diagonal of 3.74 mm. The overall imaging lens track length along the optical axis from front vertex to the image plane is 122.8 mm and the LP-smudge is located about 25.6 mm behind the image sensor.

The imaging lens design of FIG. 9A, as detailed in the prescription of FIG. 9E, also performs well relative to classical lens design metrics. In particular, an imaging resolution with more than 50% MTF is achieved for all fields at 100 lp/mm which is the Nyquist frequency. This lens has a residual pincushion type distortion at the image plane which is less than 1.5% across the entire field of view. The relative contributions to this low distortion, within the design, can be examined with the surface contribution data. In this example design, the compressor lens elements contribute a positive third order distortion (+2.38), while the wide-angle group lens elements provide a compensating negative distortion (−2.09), netting a surface contribution sum for the entire lens of +0.29. A similar tally can be done for the 5th order distortion surface contributions, which again shows that the wide-angle group was designed to nominally cancel the positive distortion contributions of the compressor lens group. In combination, the total 3^{rd} and 5^{th} order contributions combined to contribute to the aforementioned 1.5% distortion over the field of view.

This lens design also has residual lateral color at the image plane of <0.7 microns (mm) blue to red, <1.7 mm blue to green and <2 mm green to red. As these values are all sub-pixel, relative to an intended sensor pixel size of 2.5 mm, the residual lateral color is essentially un-noticeable. The relative illumination (RI) is also high across the imaged field, dropping to only ≈63% at the edge of the field. Also, FIG. 9F shows that the thermal behavior of this imaging lens has also been considered. The through focus MTF curves at 100 lp/mm, taken over a 40C temperature range, show low thermal sensitivity. In a previous version of this lens design, there was a fourth lens element that used an optical plastic, but that version had considerable thermal sensitivity for the field outer angles in the range 30-37.4°.

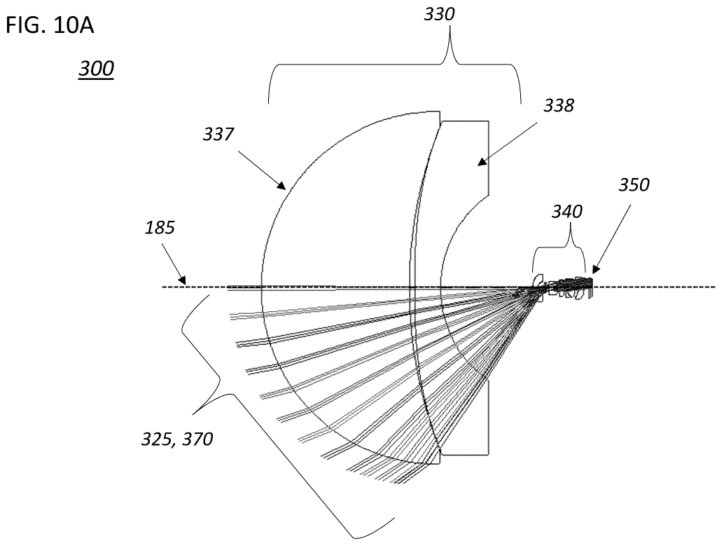

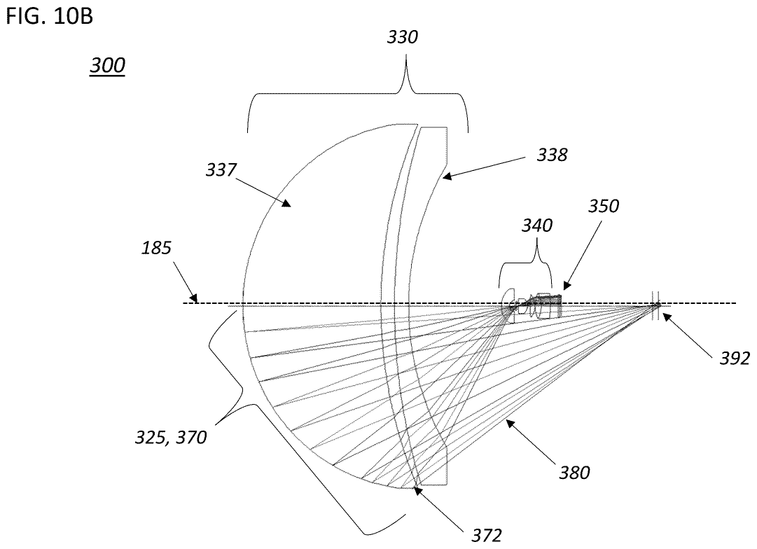

FIG. 10A depicts an alternate example lens design to that of FIG. 9A. In this example, the improved objective lens 300 has two compressor lens elements 337 and 338 that use a low index and high index pair (Δn˜0.17) of optical plastics (PMMA and OKPA2) for color correction, but they have substantially different lens element shapes from those provided in FIG. 9A. FIG. 10B depicts an additional alternate example lens 300 to that of FIG. 9A, which has compressor lens elements that are intermediate in shape to those of FIG. 9A and FIG. 10A, but where the low index lens element using E48R precedes the high index element that uses OKP4 (Δn˜0.07). These various designs vary in detail in terms of aberration control or image quality, the number of conic or aspheric surfaces, the presence of lens elements in the wide-angle group 340 that resemble modern lenses in smart phone cameras, their parallax performance, their sensitivity to ghost light and thermal defocus, and/or other factors. But the lenses of FIG. 9A, FIG. 10A, and FIG. 10B were all designed by applying the new lens design method 600 of FIG. 7, to include an improved compressor lens group.

All of these example lenses 300 have compressor lens elements (group 330) that use optical polymers, but which still provide enhanced control of both parallax and front color. Doing so provides greater freedom with surface shapes, lowers unit lens costs, and reducing total lens weight. But as compared to other low-parallax lens designs that have all glass compressor lens elements, it can then be beneficial to have some elements in the wide-angle group use very high index materials to offset the loss in optical power in the compressor group, due to the switch from high index front glass elements to a low index polymers.

It is noted that similar lenses to those in FIG. 9A and FIGS. 10A,B, with the two-element form for the compressor lens group 330, can be designed using the improved method 600 of FIG. 7, to provide enhanced control over parallax and front color optimization, while using glass lens elements instead of optical polymer lens elements for the compressor lens elements. As yet another alternative, these two compressor elements (337 and 338) can consist of a glass lens element and an optical polymer lens element, in either order.

As another example FIG. 11A depicts an alternate imaging lens 300 that was designed using the improved method 600 of FIG. 7, where the image size was required to be larger, but the imaged angular field of view was smaller (˜24 deg maximum), as compared to the example lenses of FIGS. 9A-F and FIGS. 10A-B. In this example, a 2-element compressor group 330 using optical plastics was not realized because the curvature on the front of first compressor lens element 337 was too strong. A design with a viable 3-element compressor group 330 using optical plastics was then obtained. However, by changing the first compressor lens element 337 to a midindex low-dispersion glass (e.g., Ohara SLAL-19 (n˜1.72)), a 2-element compressor solution was obtained. The second compressor lens element 338 used optical plastic OKPA2. Notably, this design solution weighed 1290 g. 980 g more than the 3-element plastic solution. However, its thermal sensitivity was lower than the 3-element plastic solution.

As yet another example, FIG. 11B depicts the pre-aperture stop (345) portion of an alternate imaging lens 300, with virtual projected chief rays 380, that was designed using the improved method 600 of FIG. 7, in which a 3-element plastic compressor group 300 was obtained. FIG. 11C then depicts the complete lens system, including the lens elements of the wide-angle group 340 that are located post-aperture stop 345. FIG. 11C also depicts edge of field virtual projections of chief rays 380, directed towards edge chief ray NP point 392. This lens 300 is analogous to that of FIG. 6, although the maximum field of view is ˜24 deg., as with the example lens 300 of FIG. 11A.

During the design of this example lens, the lens design method 600 was modified. Essentially an intermediate step 645, between steps 650 and 660 was included, during which the first three, pre-aperture stop wide angle group lens elements of the intended wide-angle (WA) group 340 were included (e.g., FIG. 11B), but not allowed to vary, while the design of the three-element compressor group 330 was further modified. For example, the design of second or third compressor lens elements can be modified to reduce color aberrations such as front color or color differences in the PSA. The space required for three plastic elements was 5 mm more than for the prior example of FIG. 11A with just one glass and one plastic lens element. The R/#, which is a metric for lens shape, on the front of the first compressor lens element 337, was reduced from R/0.508 (nearly a hemisphere) to R/0.55 by using an extra compressor element (339). Thus, with this modified method including step 645, the compressor group 330 design accounts for all contributions to aberrations of the entrance pupil. For the final lens design optimization, the resulting three compressor lens elements were then combined with all of the lens elements of the entire WA group 340.

The resulting objective lens 300 of FIG. 11C consists of 11 lens elements. Elements 1-3 are plastic (E48R, E48R, OKPA2). Element 5 has an aspheric and a conic surface. Elements 9-10 have one aspheric surface each. The lens has a focal length of 14.9 mm and an aperture of F/2.8. Its half field of view is 23.8° and it supports an image semi-diagonal of 6.55 mm. The track length is 119.7 mm, and the LP-smudge is located about 29.2 mm behind the image sensor or image plane 350.

FIG. 11D shows chief rays across all fields in the vicinity of the paraxial entrance pupil 390 for the example objective lens 300 of FIG. 11C. In this case, the LP-smudge volume is very small and shows little shift in the position (crossing of the optical axis 185) with field. This results in very low residual angular parallax within the field of view of this lens, of less than 0.03° for green light, and less than 0.07° for either red or blue light. Also as compared to the example of FIG. 9B, the paraxial (390), mid field (392), and edge of field (394) NP points are tightly clustered, although there are subtle variations therein. Distortion, which again benefited from the wide-angle group contributions generally cancelling those of the compressor lens group, is less than 1.3% across the entire imaged field of view. Lateral color, at less than 0.7 μm, is again sub-pixel. Corrected front color, at less than or equal to 0.2 mm between red and blue light, is again small compared to the estimated geometric beam size on the first compressor lens element of 6.5 mm. Image resolution, as measured by MTF, is greater than 40% for all fields at 200 lp/mm. Relative illumination (RI) at the edge of the imaged field is about 75%. The total weight for all of the lens elements of the lens 300 of FIG. 11B is estimated to be 311 grams.

As compared to the example lenses of FIGS. 9A-F and FIGS. 10A-B, with the FIG. 11A and FIG. 11B-D lenses, the reduction in the total field of view eased the design of both the compressor lens element group and the wide-angle group. However, the relative increase in the size of the image sensor somewhat compensated in adding some burden to the wide-angle group design.

But broadly speaking, application of the improved lens design method 600 of FIG. 7 has enabled significant lens performance improvements over the prior lens design methods for low-parallax camera or objective lenses. The meniscus lens shape is used to locate the entrance pupil or LP smudge behind the sensor plane and limits residual parallax. In particular, having more precise control of the meniscus shape of the outer compressor lens element controls the parallax by directly reducing the entrance pupil spherical aberration (PSA) at or near the entrance pupil or LP smudge (see FIG. 4C and FIG. 8B). The PSA can be estimated in the lens design software in various ways, including as an average RMS lateral departure or radius of the chief rays across a plane within the LP smudge (e.g., low parallax volume 188), or as a transverse error (LP-smudge radius) vs field. As an example, for the low-parallax imaging lens 300 of FIGS. 9A-F, the average PSA over 12 fields, measured as an RMS lateral chief ray error within the LP-smudge, was only 0.18 mm. As another example, for the low-parallax imaging lens 300 of FIGS. 11B-D, the estimated PSA, averaged over the field of view, was only 0.023 mm. A good design target value, for lenses designed to image half FOVs of ˜20-40 deg., is to have an average PSA over the field of view, as measured as an RMS lateral chief ray error within the LP-smudge, be less than or equal to less than or equal to 0.30 mm.

Additionally, as compared to prior low-parallax lenses, application of the improved lens design method 600 of FIG. 7 has significantly reduced the front color artifact. In particular, both example lenses, to less than or equal to 0.2 mm front color, as compared to the 0.5-0.6 mm values that were generally seen in prior low-parallax lens designs. Moreover, these improved results have been obtained while using low index (e.g., n (vis) to less than or equal to 1.60) crown glasses, with an Abbe or v-number greater than or equal to greater than or equal to 55 for at least the first compressor lens element 337 instead of needing a high index flint glass or a specialty material such as ALON. Alternately, the first compressor lens element can be a mid-to-high refractive index glass (1.6 less than or equal to n less than or equal to 1.8) that has a dispersion near the associated crown/flint borderline (crowns have a v-number greater than or equal to 50), in the v-number greater than or equal to 40 range.

In several new lens designs, including that of FIGS. 9A-F, the first compressor lens element is a low index (n(vis)˜1.55) plastic crown (E48R). Use of low index crown glasses or optical plastics, with their low dispersion, significantly helps reduce front color, as compared to using high index flint glasses. front color can then be further controlled by the addition of a second, and possibly third, compressor lens element, with appropriate optical materials (dispersion) choices. Additionally, use of low index crown materials (e.g., BK-7) can significantly improve costs versus using high index flint glasses for the (typically) large compressor lens elements, and particularly the first compressor lens element, with its polygonal edge shaping. Also, use of low index plastics for one or more compressor lens elements can dramatically the lens element weight, and the lens system weight and cost. In these low-parallax lenses 300 for us in the visible, the second and third compressor lens elements are usually needed to help front color correction. But although the examples provided have had two or three lens elements in the compressor lens element group 330, low-parallax lens systems 300 can also be developed using the improved design method 600 that have just one lens element, or that have four or more lens elements.

Also, as noted previously, the reductions in residual parallax error and residual front color enabled by the can improved lens design method 600 of FIG. 7 can also improve the camera channel and multi-camera device design in other ways. For example, the improvements can reduce how much extended FOV 215 is provided beyond the Core FOV 205, and thus help the opto-mechanical design to reduce the seam widths and avoid differential color vignetting near polygonal edges of the compressor lens(es).

However, as noted previously, in reducing parallax (e.g., PSA) and front color, the compressor group lens elements, and particularly the first lens element thereof, provide large positive contributions to image distortion. The rest of the lens, and particularly the wide-angle lens group, are then burdened with providing substantially compensating negative distortion contributions.

As previously described the improved low-parallax imaging lens systems (300) were designed using the improved method 600 of FIG. 7 in which a preliminary design for the compressor lens group 330 is obtained in isolation, by optimizing for rays pointing towards a temporary aperture stop that is also an un-aberrated entrance pupil. Once an initial design for the compressor lens group 330 is obtained, then the entire lens 300, including the wide-angle group, can be designed, and optimized. An advantage of this improved method is that the compressor lens element group 330 is designed to do what it must do, control parallax and front color, without burdening or over burdening it with other design goals. Then when the entire lens 300 is designed, the wide-angle group 340, in part, must fix whatever first order attributes or aberrations that the compressor group 330 screwed up. As a particular example, the surface contributions to distortion for the compressor group 330, and particularly the first compressor lens element 337, typically imparts a large positive distortion. When the compressor is allowed to change shape to minimize PSA and control parallax, without regard for other aberrations, it assumes a meniscus shape. The location of the entrance pupil behind the intended image plane is the key to driving this shape. The addition of second and or third compressor lens elements (338 and 339) reduces front color but has little impact on distortion. As measured by their distortion aberration surface contributions, the wide-angle group 340 then provides a large roughly comparable distortion of opposite sign, so as to net a small residual distortion over the intended field of view.

The improved lens design method 600 of FIG. 7 also can enable more precise control over lateral color than previously. With improved targeting of the compressor lens element group by optimizing it in isolation (steps 610-640) to control parallax and front color, and with more informed material selection, both front color and lateral color can be driven to lower levels. In particular, the surface contributions to lateral color from the compressor group are lower than seeing previously. Secondly, when the wide-angle group is designed and optimized while the compressor group is frozen (step 660), the wide-angle group 340 can more precisely cancel the lateral color contributions of the compressor lens element group 330, resulting in lower final lateral color than seen by prior design methods. In aggregate, the compressor group 300 contributes large positive lateral color surface contributions, and the wide-angle group 340 contributes large negative lateral color surface contributions, and in combination, they can combine to provide negligible total lateral color. As compared to previously, optimizing for low front color is no longer a trade-off that causes higher lateral color. Of course, this resulting low to negligible lateral color can then be traded off to more normal levels while completing the design of the wide-angle group 340, to benefit the reduction of other lens aberrations.

It is noted that step 650, when the isolated compressor group 330 is attached to the wide-angle group lens group 340, can be a bit tricky. As the lens element powers, lens element spacings, and the chief ray angles have changed, or are different, the two groups may not align or mate properly to each other right away. Some standard lens design tricks that are available in the lens design software (e.g., Code V or Zemax) that can then be used to match the two lens groups together before starting general optimization.

By comparison, when undertaking the traditional method of designing a lens, all or most of the intended functional features are simultaneously present from the beginning and are represented by lens elements distributed therein. In the case of designing a low parallax lens system, this means the starting lens design has at least some compressor lens elements (group 330), and the lens elements of the wide-angle group 340 that are provided both pre- and post-aperture stop 345, included from the start. However, while the traditional method can have the right type of lens elements in nominally the right positions within the lens, it does not ensure the compressor groups does what it must do. Essentially, there is too much democracy in the optimization merit function and a less satisfactory result is obtained. The wrong sort of competition can be set up between the compressor and wide-angle lens element groups.

As an alternative to the partially sequential design method 600 of FIG. 7, a more classical lens design approach or method can be adapted to achieve comparable results. Instead, the entire lens, including the compressor lens elements (group 330), and the lens elements of the wide-angle group 340 that are provided both pre- and post-aperture stop 345, can be kept together and simultaneously optimized. But in this case, the lens design merit function can be modified to include some compressor group only constraints that are targeted to parallax and front color control. These constraints can be enabled using operands and weighting factors in the Code V or Zemax merit function that only affect the compressor lens elements, and/or their surface contributions to the aberrations, or aggregations thereof, and not the wide-angle group lens elements. This alternate lens design method can also use different weightings during different phases of the lens design, or have two optimization scripts, one applied during an initial compressor group optimization phase, and the second applied subsequently during optimization of the entire lens that targets image quality at an image plane. An optimization script can also have different weightings for compressor lens elements versus the other lens elements for addressing most of the standard lens aberrations. Designs for low parallax, low front color objective lenses can be produced by these alternate methods, which are equivalent to the partially sequential design method 600 of FIG. 7.

The design of the example objective lens 300 of FIGS. 11B-D has also been modified to address various applications where there are different size, weight, performance, and cost (SWaP-C) expectations. For example, where the objective lens 300 of FIG. 11C has a track length of 119.7 mm and a focal length of 14.9 mm, a similar, also manufacturable, much smaller lens was derived from the FIG. 11C, but with a track length of 9.3 mm and a focal length of 1.12 mm. Both lenses operate at the same f/# and wavelengths. This second lens is essentially the same design form as the starting lens, but as the geometric aberrations all scale down with the shrinking focal length, the lens element count can be reduced. As the lens size shrinks into the domain where plastic lens elements nominally comparable to those used in cell phones become viable, then greater freedom in lens shaping, including the use of aspheric or free-form profiles, become possible. Such changes can also enable the lenses to be designed with fewer lens elements.

As evidenced by the previously discussed improvements in lateral color by applying the partially sequential design method 600 of FIG. 7, or variants or equivalents, to improve front color and residual parallax, this new approach can provide or enable other complimentary improvements. Most simply, it can then be easier to reduce the magnitude of other lens aberrations. Also, as noted previously, in a low parallax lens of the present type, the outer compressor lens element 337 and its polygonal edges essentially act as a soft or unfocused field stop, where the edge is expanded by the finite beam width, the parallax variation, and the residual front color. Thus, by applying the partially sequential design method 600 of FIG. 7, or variants or equivalents, such as the alternate methods mentioned above. Front color and residual parallax can be reduced, which also helps the unfocused field stop be sharper. This can help both the mechanical design and the image cropping and tiling steps. Additionally, the lens system can also include a mechanical field stop, such as a plate with a polygonal shaped opening that is aligned with the polygonal edges of the compressor element(s).

The low parallax, low front color lenses 300 of the present type can also be paired with an imaging relay lens system. This imaging relay can enable use of larger image sensors, beam splitters with secondary image or optical sensors, and zooming optics. Alternately, the improved objective lenses 300 can be paired with fiber optical relays using coherent fiber bundles. These improved lenses 300 can also be used in multi-camera panoramic capture devices of various configurations, including spherical and hemispherical systems, conical systems that image less than a hemispherical total field of view, or annular systems (e.g., halo or visor systems) that, for example, image a field of view that is horizontally wide and vertically narrow. Depending on the design requirements, the system geometries can be octahedral, dodecahedral, icosahedral, or utilize the shapes and patterns of more complex Goldberg polyhedral, although polyhedral with pentagonal and hexagonal facets are generally favored as they case camera channel fabrication. In some application geometries, camera channels with square or rectangular shaping to the outer lens elements can be useful. A multi-camera device can also be fabricated where the outer compressor lens element are integrated together, to be contiguous, and form a faceted dome or partial dome. In a faceted dome system, it can be easier to shrink the seam widths, for example to less than or equal to 2 mm and preferably to less than or equal to 0.5 mm. Depending on lens channel alignment tolerances, the extended FOV 215 can then also be reduced.

Although this discussion has emphasized the design of improved multi-camera image capture devices and associated objective lenses 300 for use in broadband visible light, or human perceivable applications, these devices can also be designed for narrowband visible applications (modified using spectral filters), or for multispectral, ultraviolet (UV) or infrared (IR) optical imaging applications. In the infrared, improved low parallax and low front color lenses can be designed for the short wave (SWIR), mid-wave (MWIR), or long wave (LWIR) spectra. In such cases, the image spectral bandwidths can expand to span several microns. As the available materials change with the different spectra, the aspects of the design that are easy or more difficult can change. Nonetheless, using the improved design method, residual front color in those spectral bands can also be reduced to less than or equal to 0.1 mm in width. Polarizers or polarizer arrays can also be used. Additionally, although the imaging cameras 300 have been described as using all refractive designs, the optical designs can also be reflective, or catadioptric and use a combination of refractive and reflective optical elements. It should also be understood that the camera lenses 300 of the present approach can also be designed with optical elements that consist of, or include, refractive, gradient index, glass or optical polymer, reflective, aspheric or free-form, Kinoform, fresnel, diffractive or holographic, and sub-wavelength or metasurface, optical properties. These lens systems can also be designed with achromatic or apochromatic color correction, or with thermal defocus desensitization.

What is claimed is:

1. An imaging lens for use in a low parallax multi-camera imaging system, the imaging lens comprising:
a compressor lens element group including a polygonal lens element having a meniscus lens shape and comprising a crown optical material, the compressor lens element group being configured to refract at least a portion of incident light having a spectral bandwidth as image light within a polygonal field of view, the image light including edge of field chief rays which are accepted rays along edges of the compressor lens element; and
a wide-angle lens element group configured to receive the image light from the compressor lens element group and direct the image light to an image plane to form a polygonal image corresponding to the polygonal field of view;
wherein projections of the edge of field chief rays included in the incident light converge to a low parallax, point located behind the image plane such that light within the spectral bandwidth converge at the low parallax point.

2. The imaging lens of claim 1, wherein the meniscus shape of the first lens element minimizes the pupil spherical aberration (PSA) within a low parallax volume.

3. The imaging lens of claim 2, wherein an average PSA over the imaged field of view, as measured as an RMS lateral chief ray error within a volume of the low parallax point, is less than or equal to 0.30 mm.

4. The imaging lens of claim 3, wherein spectral differences of the incident light converged at the low parallax point are determined by the combination of the compressor lens element and one or more pre-aperture stop lens elements of the wide-angle lens group.

5. The imaging lens of claim 1, wherein the compressor lens element group introduces a positive distortion, and the wide-angle lens element group provides a nearly compensating negative distortion.

6. The imaging lens of claim 1, wherein the compressor lens element group limits both front color and parallax, while introducing a positive lateral color, and the wide-angle lens element group provide nearly compensating negative lateral color.

7. The imaging lens of claim 1, wherein the compressor group comprises a second compressor lens element, and the polygonal compressor lens element and the second compressor lens element are achromatically color corrected to control or limit front color.

8. The imaging lens of claim 1 wherein a distance between the entrance pupil and the low parallax point reduces parallax errors for the non-paraxial chief rays received proximate one of the plurality of edges.

9. The imaging lens of claim 1, wherein the compressor lens element has a visible refractive index of less than or equal to 1.6 and an abbe number of greater than or equal to 55.

10. The imaging lens of claim 1, wherein the compressor lens element has a visible refractive index greater than or equal to about 1.6 and less than or equal to about 1.8 and an abbe number of greater than or equal to 40.

11. The imaging lens of claim 1, which provides visible light imaging for a spectral bandwidth of 200 nm or greater, and the compressor group limits a residual front color along the polygonal lens edges of the first compressor lens element to less than or equal to about 0.2 mm.

12. The imaging lens of claim 1, which provides visible light imaging for a spectral bandwidth of 200 nm or greater, and the compressor group limits a residual front color along the polygonal lens edges of the image at the image plane to less than or equal to about 0.7 of an image pixel size.

13. The imaging lens of claim 1, wherein the compressor group has two compressor lens elements that combine to provide color corrected projections of the chief rays within the spectral bandwidth, such that a projection of the paraxial chief rays converges to an entrance pupil located behind the image plane; and a projection of the non-paraxial chief rays converges to a center of perspective that was optimized to be located proximate to the entrance pupil, such that perspective errors are reduced over the spectral bandwidth for at least the non-paraxial chief rays that were accepted at or near the shaped lens element edges.

14. The imaging lens of claim 1, wherein control of both front color and parallax along the polygonal edges reduces the needed width of extended field of view provided by the imaging lens.

15. The imaging lens of claim 14, wherein the extended field of view is preferably less than about 5% of the nominal field of view width, and even more preferably less than about 1%.

16. The imaging lens of claim 1, wherein control of both front color and parallax along the polygonal edges contributes to reducing the seam width the imaging lens and an adjacent imaging lens in a multi-lens device to less than or equal to about 8 mm mechanical width.
